(19) United States
(12) Patent Application Publication
(10) Pub. No.: US 2008/0013720 A1
(43) Pub. Date: Jan. 17, 2008

(54) MONOBASE AMORPHOUS ENCRYPTION

(75) Inventor: Steven T. Degele, Fargo, ND (US)

Correspondence Address: Steven Degele, 2828 36th Ave S, Fargo, ND, 58104, US

(73) Assignee: Steven Degele, Fargo, ND (US)

(21) Appl. No.: 11/307,612

(22) Filed: Feb. 14, 2006

(51) Int. Cl. H04L 9/00

(52) U.S. Cl. 380/43

(57) ABSTRACT

A cryptographically secure keystream generating process includes an expanding amorphous process. A seed key is expanded into a partition index that is carved into elements (parameters) by a parallelizable process. A dispersing value is derived from the partition index to de-cluster subsequent partition indexes. The process operates with constant entropy by “recarving” elements and employs block holdbacks for increased variance during multiplexing. Internal emissions are derived from the amorphous process itself, which provide secure random sources for subsequent use within the keystream generation process. Seed key expansion and dispersing value computation both use cyclic redundancy code evaluation employing multiple polynomials. A public (mono) base key family is defined with three preferred modes, two of which are specialized for software implementation. Two private base key embodiments are included that constantly morph the base key.

### BACKGROUND OF THE INVENTION

The present invention generally concerns cryptographic machines and processes, particularly as regards generation of cryptographic keys. The present invention still more particularly concerns cryptographic machines and processes that serve to generate cryptographic keys of indeterminately long length.

The amorphous process for generating a cryptographically secure keystream falls into several categories and subcategories. These are described in detail in this inventor's prior patent, U.S. Pat. No. 5,297,207. Some of these processes are computationally inefficient, or have poor memory usage, or provide a less rich set of combinations. These embodiments are of lesser interest.

The strongest embodiment within the previous patent was an expanding amorphous process with contiguous elements driven by a random stream. This embodiment is also the basis of the present application. Therefore, pertinent details of this embodiment from the prior patent are described below. The deficiencies of this embodiment, as noted in the following paragraphs, have been addressed by the present invention. The inventor has not found any reference to a third party attempt to analyze or enhance the amorphous process as described in the prior patent.

However, there has been very significant progress in other areas of the field of cryptology over the last decade. Of special interest to the present invention are the results pertaining to linear feedback shift registers (LFSR). In brief, algebraic attacks and fast correlation attacks have rendered many LFSR based configurations cryptographically insecure. It appears that secure systems require techniques such as complex clocking or decimating the output in a very complex manner.

The focus of cryptographic research has been on systems with compact complexity. This has great theoretical and practical importance as it sheds light on the basic building blocks. Yet, little attention has been given to large state systems such as may use an amorphous process where complexity is based on the size of the state. A notable exception is RC4, an elegant permutation based keystream generator from 1987 whose key defines a permutation of 8-bit elements. Several independent researchers have analyzed RC4 in recent years. And while its original Key-Scheduling Algorithm renders RC4 insecure, the core idea remains sound. But in general, the focus has been with compact complexity. This situation seems shortsighted considering the constant advances in microelectronics renders compact complexity of potentially secondary importance.

Regarding the inventor's prior patent, the expanding amorphous process begins with a relatively large base key and a much smaller partition index, both being ordered sets of random bits. The partition index specifies how the base key is partitioned (i.e. decomposed) into a random bit stream called the amorphous stream. The leading portion of the amorphous stream is feed back as the next partition index with the remainder defined as the keystream fragment. Successively applying this process yields a series of fragments whose concatenation forms a keystream of indeterminate length.

This indeed is a practical means for generating a cryptographically secure keystream. But the size of the base key is a storage bottleneck, a typical value being around the 64K bytes. This is significant as the base key is part of the secret key. For manageable storage requirements, the prior patent suggested that the base key be represented by a smaller base key seed (say 256 bits) that would be expanded to the base key on demand.

This is a feasible approach. But it has the high cost of generating a base key as the initial step. This introduces considerable latency into the encryption process, which could be prohibitive for high volume transaction systems.

Regarding the partition index, a means was devised to expand a small message key (say 256 bits) into approximately a 3K byte random number that was used as the partition index. Again, this was a viable approach, and for most practical purpose, a necessary one. Furthermore, the message key expansion means was very non-linear and arguable quite secure. However, it was also rather convoluted. But worse, it was slow, introducing yet more latency into the encryption process.

During keystream generation, a new partition index is generated at each feedback stage for the successive keystream fragment. However, a significant problem exists with the sequence of partition indexes. Toggling the value of a single partition index bit, depending on its position, could have little effect (or even none) on the next partition index and keystream fragment. This gives rise to a clustering effect whose consequent is less variety in keystreams and smaller cycle lengths before repetition begins.

At the heart of the expanding amorphous process is mapping. Mapping specifies how a partition index decomposes the base key into a random bit stream. The original embodiment had three main mapping features: 1) a multiplicity of permuted elements, 2) element emissions (bits streams) defined per element, and 3) a multiplexer that combines the element emissions into the random bit stream.

Mapping begins by carving the base key into contiguous blocks called elements. Each element is further decomposed into two sources (these were called fronts and tails in the prior patent). Each source defines a bit stream whereupon both streams are combined to form the element emission. The elements are permuted by using a random permutation defined by the partition index. The partition index also defines the element sizes and element source sizes, as well as the starting positions within sources, and so forth.

Element emissions are formed from source bits in a bitwise fashion. This is the most powerful granularity, and the chosen embodiment was relatively simple. However, bitwise generation hinders performance in software implementations as modern CPU's are geared towards word operations, not bit operations.

The third and last mapping feature regards the multiplexer. The multiplexer forms the random bit stream by successively concatenating a bit from each element emission with the elements accessed in permuted order. In addition, the multiplexer selectively skips elements via holdback counts, which are defined per element.

The holdback multiplexer does make correlation of the random bit stream to element emissions hard. And several holdback enhancements were noted in the prior patent. But the correlation complexity introduced wasn't always on par with the computational costs.

The original holdback multiplexer does prevent extracting a long bit sequence that comes from the same element. But for each emission and its successor, there is a high probability these came from two adjacent elements. This could lend itself to a correlation attack based on adjacent elements.

The original mapping system has several other defects. For example, elements were dropped once their emissions were exhausted, which caused a decrease in entropy as the keystream fragment is generated, resulting in the trailing bits being weakly generated. Also, the element count was dynamic, which resulted in non-uniform entropy for the message keys. Another defect dealt with the parameterization of the initial holdback value used by the multiplexer, which resulted in a leading portion of the keystream that was generated without holdbacks.

Another defect stemming from mapping results in emission fragment refill accumulation. Namely, the emission fragment refill requests tend to be grouped together with many consecutive elements requiring a refill: one after another. This introduces two problems. First, it is a performance bottleneck as the multiplexing must wait for refills before continuing. Secondly, it results in the substitution bits being emitted in a fairly regular manner within the amorphous stream. This is dangerous when the substitution source is a LFSR because it opens the door to correlation attacks.

But one of the greatest shortcomings is that the mapping system did not lend itself to parallel processing. There are two causes for that. First, there is a dependency on an element's starting position to the preceding element. Secondly, random permutations have the characteristic that calculating the next random index is dependent on the prior calculations. These dependencies are undesirable as they prohibit using multiple logic units to reduce the partition index carving time.

Still another defect is that the partition mapping is loosely coupled. Namely, the major components of the amorphous process (substitution source, path source, emission fragment generator and multiplexer) are somewhat independent. Thus, a divide and conquer attack is possible on each component. This results in the strength of the encryption system being much less than the initial partition index size.

A final defect is that the full expanding amorphous process system is rather large. This makes it less attractive for low cost applications based on hardware implementations.

### SUMMARY OF THE INVENTION

The present invention is an expanding amorphous process used to generate a cryptographic keystream, typically used for encryption of data. The process begins with a base key, which is an ordered set of random bits. However, with the present invention, the base key is public. Furthermore, there is only one base key designated for universal use. From this fundamental concept, monobase amorphous encryption (MAE) takes its name. (The morphing-base version will be described further on.)

In simplest terms potentially understandable by even those parties who are somewhat unfamiliar with encryption or encryption key generation, the present and a related predecessor invention of U.S. Pat. No. 5,297,207 deal with encryption, and particularly encryption key generation, with and by systems and methods that can assume a very large number of states, where the number of states assumable is related to the difficulty of an intruder in recovering the key and in crypto-analyzing an encrypted message. The system and method of the present and related invention particularly use an amorphous process where complexity is based on the size of the state, not some mathematical process.

The chief advantage of monobase amorphous encryption (MAE) in accordance with the present invention is that large private base keys are no longer needed for amorphous encryption. In short, the corresponding computational and/or storage costs have been eliminated. In particular, the overhead of computing base keys is gone, which is imperative for low latency encryption. But a public base key places stringent requirements on the underlying amorphous process. The present invention addresses that, in part, by increasing the size of the partition index.

The partition index is the private key. But typically, a smaller message key is expanded into the initial partition index. In its basic form, MAE key expansion first forms two seed values from a message key using two independent non-linear calculations. Each seed is used by a linear feedback shift register (LFSR) whose outputs are exclusive-ored (xored) together to form the partition index. This method has the advantage of minimal latency with respects to partition index stream generation, while still incorporating two non-linear elements, namely i) seed evaluation and ii) xoring of LFSR outputs. Together these provide a sufficiently secure process. It also achieves the necessary “avalanche” sensitivity with respect to input and output.

While generating the keystream, a sequence of partition indexes is formed via feedback. If the prior invention's amorphous process is used, these partition indexes exhibit clustering because a slight partition index change typically results in relatively few different bits between the corresponding next partition indexes. The present invention solves the clustering problem by using a dispersed seed. In brief, the partition index is hashed with the digest value used as the dispersed seed. The dispersed seed is used by the emission generator, which effectively triggers an avalanche randomization of the amorphous stream.

The present invention also employs a superior mapping method for decomposing a partition index into elements. The first improvement is the use of random start addresses for elements. Namely, a sequence of partition index bits is used to define a random address within the MAE base key. This accomplishes two things. First, it eliminates the dependency of the starting position of one element to the next. Secondly, it eliminates calculating permutation values, which is also a non-parallelizable operation. Furthermore, besides simplicity and being parallelizable, random start addresses yield a set of elements based on combinations, which have more possibilities than what a permutation provides. (Random start addresses were used in the prior invention, but only for the amorphous processes based on dispersed elements: the inventive step regarding parallelism and combinations was not taken.)

In brief, by eliminating processing dependencies, the present invention enables parallelizable partition evaluation. With faster partition index carving, the door is open for applications requiring low latency.

A related improvement is using an independent random start address for each source, wherein each element typically contains two sources. The prior invention essentially divided a contiguous block of bits to form two adjacent sources whereas the element sources of present invention can be anywhere in the MAE base key thereby yielding a richer set of possible element emissions. As a side note, the hole specification of the prior invention is no longer used as it doesn't apply to independent sources.

Another mapping improvement is the use of independent initial position selection for each source via independent rotation specifications. These replace the single initial item specification of the prior invention, which is an improvement because more (desired) bits are used by the new specification values.

Another mapping improvement is recarving elements instead of dropping them after their emissions are exhausted, which results in uniform amorphous process entropy. In brief, a portion of the partition index is defined as a recarving generator seed from which the recarving bits are derived. From the recarving bits, new elements are carved as needed. Element recarving provides for constant entropy of the amorphous process, albeit via an internal generator providing for some of the state entropy.

To eliminate emission fragment refill accumulation, a mapping improvement based on an initial fragment size was introduced. This value, derived when carving each element, specifies the number of bits to generate when the fragment register is filled for the first time. This results in a random distribution of element refill requests, thus spreading out the emission fragment generation, which improves throughput. It also eliminates emitting substitution bits in a regular manner, making for a more secure system.

Another mapping improvement deals with the initial holdback value. The prior invention directly used a portion of the partition index to define a random value, which seems innocuous enough. However, the maximum initial holdback was much less than the minimum master holdback, which resulted in a significant portion of the amorphous stream to be generated without holdbacks. This is somewhat a parameterization problem as increasing the maximum initial holdback value largely mitigates the issue. However, the present invention fully addresses the problem by calculating a random number scaled by the master holdback count thereby providing an unbiased initial holdback value.

A significant improvement was also made to the holdback multiplexer with the introduction of block holdbacks. Here, recarving bits are used to define a “random” holdback trigger and holdback block size. When triggered, the multiplexer skips a block of elements. This greatly increases the holdback variance with respects to the holdback count, which makes separating element emissions proportionately harder.

To reduce the correlation attack surface stemming from adjacent element emissions, three multiplexing related improvements were introduced. The first is called assigned sources. Assigned sources consist of a pool of sources, typically two sources per element, which initially are sequentially assigned to the elements. Periodically (say after 8 block holdbacks), the sources are reassigned wherein a random source is used to select sources from the pool and assign them to the elements. This results in each element emission coming from constantly changing sources.

The second technique to reduce element adjacency is called dynamic sources. Here, the length of each source is very small, say half the size of the emission fragment. When a source is exhausted, it is randomly refilled via a random source that selects a new base key address. Dynamic sources provide the same benefit as assigned sources, but its effective source pool is much larger, though it does require more processing power.

The final improvement that reduces element adjacency is called alternate nexts. Instead of sequentially chaining the elements together, alternate nexts provides one or more additional next element pointers, which are randomly derived during partition carving. Thus, instead of always advancing to the next sequential element, the multiplexer makes its selection from a plurality of elements.

Another improvement, this one at the structural level, is employing internal emissions. An internal emission is a random generator that utilizes the amorphous process itself. In brief, each element has an internal emission register for storing a value coming from a random source. When an emission fragment is generated, the register value is emitted as an internal emission with the register refilled from the random source. The random source is thus permutated by the fairly complex process of emission fragment generation and multiplexing.

Internal emissions are used as random sources for path bits, substitution bits and the like. It provides a coupling effect in that the entire system must be broken at once. For example, without internal emissions, the state of the path random generator could be guessed. This would significantly reduce the effect needed to break the rest of the system. But essentially the entire state must be guessed when internal emissions are used. Hence, internal emissions yield a system whose cryptographic strength is on order of the partition index size.

The monobase version of the MAE keystream generator has three distinct embodiments, which are referred to as modes. First, there is canonic mode. Canonic mode uses bitwise processing and is geared towards a hardware implementation, though software implementation was considered as well. Since microprocessors are usually optimized for word operations, two additional modes were created for enhanced performance of software based systems: namely accelerated mode and blazing mode. Without loss of generality, these two modes are described below using typical values for concreteness.

Accelerated mode uses a faster emission generator based on word aligned memory addressing and various logical operations that are typically supported by CPUs. Furthermore, element emissions are multiplexed a byte at a time. These yield a significant performance gain with accelerated mode running about three times as fast as canonic mode.

Accelerated mode is on par with canonic mode with respects to the cryptographic strength of its emission generator. However, 8-bit multiplexing is very weak. Two steps were taken to address that. First, multiplexing is applied to slots instead of directly to elements, with a typical embodiment having four times as many slots as elements. Each slot is randomly assigned an element resulting in four chains of permuted elements, though actually these comprise combinations rather than permutations. Each slot also has an independent holdback count. This mapping embodiment increased the partition index size (which was desired as it provides a richer stream) without significantly degrading the partition carving and keystream generation performance.

However, correlating the multiplexer's output to the element emissions is still a trivial task. The final step to fix this is the addition of a mixing stage. The mixer takes four bytes at a time and performs a partial permutation via a sequence of rotations controlled by a random stream. The resulting amorphous stream is correlation secure; i.e. given the emission streams and amorphous stream, discovering the multiplexing parameters is an intractable problem.

Blazing mode is the other embodiment geared towards software. To achieve a substantial performance gain over accelerated mode, both emission generation and multiplexing were revamped. Emission generation was reduced to the bare minimum. Namely, two source values are each randomly rotated and then xor-ed together. This provides for a light-weight permutation, but the substitution component was entirely dropped from emission generation for the 32-bit version except in the rare case when both source values have the same base key address (the 64-bit version still uses substitution bits). Regarding multiplexing, the mixing stage was eliminated.

To preserve blazing mode keystream security, several features were added. First, the random generator that drives the random source rotations was enhanced. Blazing mode also uses multiplexing slots, but here, three slots with independent holdback values are associated to each element with the multiplexer successively cycling through the slot positions as it processes holdbacks. While these two features improve the keystream security, it does not help prevent a direct emission/amorphous stream correlation. But the multiplexer does thwart determining the element emissions when only the keystream is known.

A critical feature for securing blazing mode is the use of a morphing random base key. The base key is preferably generated from a canonic mode process so that a monobase key is still effectively used regarding the public key. A private blazing base key prevents a table based attack, which would be practical for blazing mode if a public base key was used. Finally, the private blazing base key is randomly modified as each partition is carved. With morphing, base key extraction becomes a moving target. Arguably, determining the base key is rendered an intractable problem as the entire base key will be replaced before identically generated values are emitted with any frequency.

The morphing-base version of the MAE keystream generator is now outlined. Strictly speaking, blazing mode is a morphing-base system. But the two morphing-base embodiments being outlined here are characterized by a base key that essentially coincides with the state of a collection of random generators. Without loss of generality, these random generators will be expressed as LFSR's, which is the typical choice. In brief, each LFSR provides an element emission with the partition index providing the initial state for each LFSR whose totality is viewed as the base key. Periodically, the LFSR states are modified (morphed). As with other MAE embodiments, holdback multiplexing is used to form the amorphous stream.

The first morphing-base embodiment is geared towards hardware implementations where minimal chip size is desired for low cost products. It emits one bit per multiplexing step and utilizes an incremental next partition index. Namely, the elements are systematically recarved piecemeal instead of all at once. This eliminates the need for the next partition index register, which is fairly large, typically over 5 KBytes. Furthermore, explicit base key memory is not needed as that is handled by the LFSR's.

The other morphing-base embodiment is geared towards software. It emits multiple bits per multiplexing step to achieve greater throughput, and compares favorably with accelerated and blazing modes.

The final concept of the present invention is multi-dimensional cyclic redundancy code (MD-CRC) evaluation. MAE uses MD-CRC units for fast hashing in two important areas: key expansion and dispersed seed evaluation. Standard CRC evaluation is a division type hash function based on a single polynomial used as the divisor wherein division in “CRC math” is the xor (exclusive or) operation. A multi-dimensional CRC is comprised of a plurality of polynomials that are successively used as divisors during evaluation. The polynomials space is much larger for a MD-CRC, thus there is the potential for a better hash at the same performance cost.

Many of the invention's improvements are simple. However, they represent judicious choices resulting from careful analysis, yielding simplified operation while increasing the security of the generated keystream. As with the amorphous process in general, MAE exhibits an elegant simplicity, making for easy crypto-analysis so as to provide high confidence of its security.

### BRIEF DESCRIPTION OF THE DRAWINGS

FIG. 1 is a block diagram of a MAE keystream generator using an expanding amorphous process utilizing a universal base key.

FIG. 2 is a block diagram of a message key exploder used to form a partition index from a private message key and a public key delta for the MAE keystream generator of FIG. 1.

FIG. 3 is a table that illustrates the arithmetic evaluation used to calculate the work key of FIG. 2.

FIG. 4 is a block diagram of a partition index manager used to transform a partition index and to derive element specifiers for the MAE keystream generator of FIG. 1.

FIG. 5 is a block diagram of an element recarver used to generate element specifier bits that form new element parameters for the MAE keystream generator of FIG. 1.

FIG. 6 is an illustration that depicts the partition index clustering that is present when a dispersed seed is not used.

FIG. 7 is a table used to define the specification fields that comprise an element specifier, which are used in the canonic mode version of the MAE keystream generator of FIG. 1.

FIG. 8 is a table used to define the element descriptor registers that comprise a canonic mode element descriptor, which are evaluated from a portion of the specification fields of FIG. 7.

FIG. 9 is a table used to define the multiplexer slot registers that comprise a canonic mode multiplexer slot, which are evaluated from a portion of the specification fields of FIG. 7.

FIG. 10 is a block diagram of an emission generator used to form element emissions while operating in canonic mode which are then multiplexed by the MAE keystream generator of FIG. 1.

FIG. 11 is a block diagram of a holdback multiplexer used to form an amorphous stream for canonic and accelerated mode operation for the MAE keystream generator of FIG. 1.

FIG. 12 is a table used to define the specification fields that comprise an element specifier, which are used in the accelerated mode version of the MAE keystream generator of FIG. 1.

FIG. 13 is a table used to define the element descriptor registers that comprise an accelerated mode element descriptor, which are evaluated from the specification fields of FIG. 12.

FIG. 14 is a table used to define the slot specification fields that comprise a slot specifier, which are used in the accelerated mode version of the MAE keystream generator of FIG. 1.

FIG. 15 is a table used to define the multiplexer slot registers that comprise an accelerated mode multiplexer slot, which are evaluated from the slot specification fields of FIG. 14.

FIG. 16 is a block diagram of an emission generator used to form element emissions while operating in accelerated mode which are then multiplexed by the MAE keystream generator of FIG. 1.

FIG. 17 is a block diagram of an accelerated mixer used to permute bits to form an amorphous stream for accelerated mode operation for the holdback multiplexer of FIG. 11.

FIG. 18 is a table used to define the specification fields that comprise an element specifier, which are used in the blazing mode version of the MAE keystream generator of FIG. 1.

FIG. 19 is a table used to define the element descriptor registers that comprise a blazing mode element descriptor, which are evaluated from a portion of the specification fields of FIG. 18.

FIG. 20 is a table used to define the multiplexer slot registers that comprise a blazing mode multiplexer slot, which are evaluated from a portion of the specification fields of FIG. 18.

FIG. 21 is a block diagram of an emission generator used to form element emissions while operating in blazing mode which are then multiplexed by the MAE keystream generator of FIG. 1.

FIG. 22 is a block diagram of a holdback multiplexer used to form an amorphous stream for blazing mode operation for the MAE keystream generator of FIG. 1.

FIG. 23 is a block diagram of a morphing keystream generator based on an expanding amorphous process, which utilizes a base key that is constantly transformed.

FIG. 24 is a table used to define the specification fields that comprise an element specifier, which are used in the single emit version of the morphing keystream generator of FIG. 23.

FIG. 25 is a block diagram of an element emitter used to form an element emission whose internal registers are initialized with values derived from the single emit element specifier of FIG. 24.

FIG. 26 is a table used to define the specification fields that comprise an element specifier, which are used in the multiple emit version of the morphing keystream generator of FIG. 23.

FIG. 27 is a block diagram of an element emitter used to form an element emission whose internal registers are initialized with values derived from the multiple emit element specifier of FIG. 26.

FIG. 28 is a block diagram of a MD-CRC calculator used to evaluate a multi-dimensional cyclic redundancy code from an input stream.

### DETAILED DESCRIPTION

1. Overview of Monobase/Morphing Amorphous Encryption Embodiments

The expanding amorphous process is the basis for the present invention, which has two primary versions that differ in base key usage. The first version uses a single (mono) base key while the other uses a morphing base key. The overloaded acronym MAE refers to both versions, and the innovations described herein are generally applicable to both versions. However, some innovations are more apt than others for specific embodiments as will be described in due order.

The mapping and multiplexing techniques that comprise MAE lend themselves as design parameters so that various implementations based on tradeoffs of speed, size, format, and security level are readily possible. For example, some techniques require more processing power. Hence within a software implementation, the basic techniques could be used in a level 1 system with more process intensive techniques used in a more secure level 2 system. Fortunately, hardware implementations could easily support both levels without a performance penalty.

Several innovations will be classified as level 2 techniques based on the performance/benefit considerations. Though happily, the recent introduction of dual core CPU's (which likely will become standard) renders this distinction fairly moot. Specifically, the holdback multiplexer stage is the bottleneck on a single CPU system. But with multiple CPUs, the generation stage could utilize one CPU with multiplexing performed on the other. This permits using level 2 techniques while still achieving the same throughput. The embodiments of MAE soon to be presented readily support this parallelism.

MAE uses pseudo random number generators in several places (for path bits, substitution bits, etc) while generating its own random keystream. These are generically referred to as random sources, and generally can be any suitable random number generator. However, random sources based on LFSR's are particularly useful. LFSR's are fast, simple and generate excellent random numbers. Their only defect is that they are not secure, even when combined in rather complex ways.

However, a LFSR can be used as a mini one-time pad. Namely, the first n bits are completely secure (where n equal the length of the LFSR). MAE uses random sources in a manner that results in achieving this mini one-time pad effect, which is of particular importance for the morphing-base version. The one-time pad effect is achieved via multiplexing. This thwarts fast correlation attacks by scattering the parity relationships imprinted by the LFSR's connection polynomial upon which such attacks are based.

In the embodiments subsequently described, the details for the random sources may not be given. But generally, a LFSR with a primitive polynomial would suffice. In places where a random source is more critical, suitable detail will be provided. Of course with multi-core CPUs, beefier random sources are practical as a level 2 technique.

2. Monobase Amorphous Encryption Keystream Generation

The monobase version of the MAE keystream generator is considered next, which has three distinct preferred embodiments that share a common structure. The term mode is used to distinguish between these embodiments. The key difference between these modes is the multiplexing emission rate. The primary mode is the canonic mode, which is the full blown amorphous process that employs a small multiplexing emission rate. The other two modes, accelerated and blazing, are concessions for software implementation, with multiplexing emission rates of medium and large, respectively. The details for the common functionality and mode specific functionality will general reside in their own sections. But at times, they will be intermingled to make for better document readability.

The full details of the system are given because the improvements are very intertwined with the basic operation, which is quite simple to begin with. However, the novel components of the invention are explicitly noted.

3. Generic Mode Keystream Generation

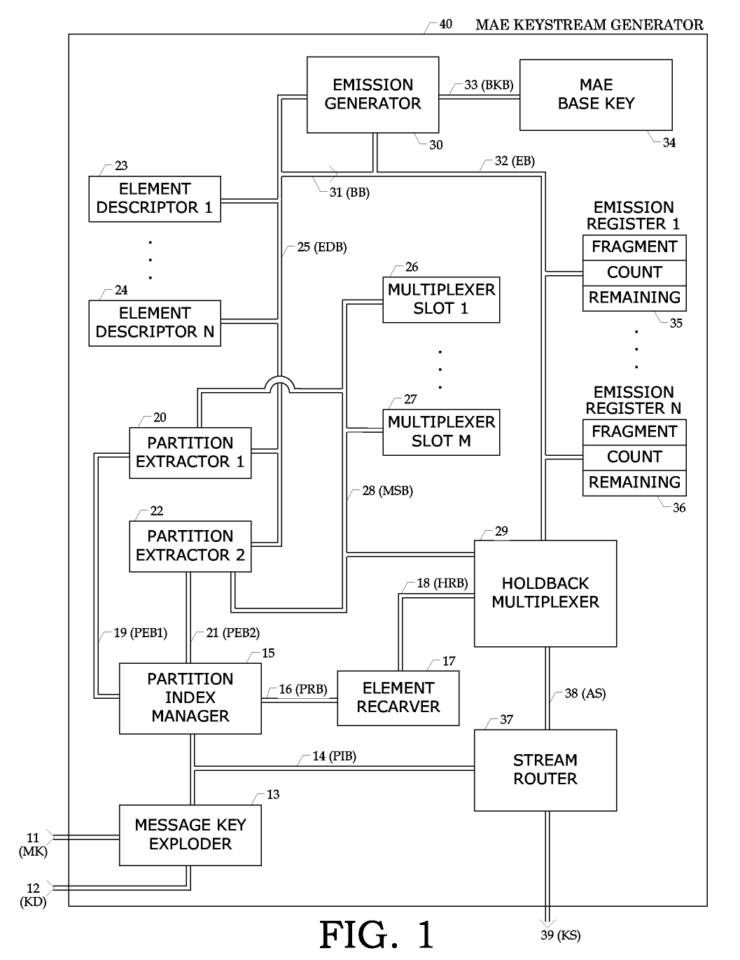

The MAE keystream generator 40 of FIG. 1 is described first. This will provide an overview of the amorphous process operations that are substantially common to all modes. Details for particular operations as well as details specific to the canonic, accelerated and blazing modes will be subsequently described.

The MAE keystream generation process begins by sending message key 11 and key delta 12 into message key exploder 13 to form an initial amorphous partition index. Partition index manager 15 receives the initial partition index, stores it and sends a copy to element recarver 17. Partition index manager 15 also decomposes the stored index into a sequence of specifiers, which are sent to partition extractor 1 20 and partition extractor 2 22.

The primary function of partition extractors is to fill the element descriptors and the multiplexer slots by evaluating the specifiers into values and routing those values to the appropriate registers. There is a plurality of element descriptors, one for each of the N elements, depicted as element descriptor 1 23 and element descriptor N 24. There is also a plurality of multiplexer slots; depicted as multiplexer slot 1 26 and multiplexer slot M 27. There are M slots, with one or more slots allocated per element, depending on the mode. (In the prior patent, the multiplexer slots were labeled Holdback Register 1 through Holdback Register N. They serve the same purpose, though the multiplexer slot notation is more generic.)

Partition extractor 1 20 and partition extractor 2 22 route the evaluated values through the element descriptor bus 25 and multiplexer slot bus 28. For diagram clarity, only two extractors are shown and a single bus for the element descriptors and a single bus for the multiplexer slots. However, the partition carving process is fully parallel, so multiple extractors and multiple busses to support the data flow could be implemented if needed. Parallel carving is a novel improvement that is crucial for low latency applications.

The partition extractors also fill the emission remaining registers that are contained in emission registers. There are N emission registers, one for each element, depicted as emission register 1 35 and emission register N 36. For each element, one of the partition extractors evaluates an emission size, i.e. the number of bits for the element emission. The emission size value is routed from element descriptor bus 25 through bus bridge 31 to emission bus 32 and finally stored in the appropriate emission remaining register. During normal partition carving, the emission size for each element is also sent to holdback multiplexer 29. But when a particular element is recarved via element recarver 17, the emission size is not sent to the holdback multiplexer. This will be fully described shortly.

The final stage of partition carving is accomplished by element recarver 17, which forms certain seed values from the partition index sent by partition index manager 15. The seed values are sent to emission generator 30 for usage therein. Element recarver 17 also forms two block holdback values that are sent to holdback multiplexer 29.

A priming step is then performed to fill two additional registers per element in the emission registers, except for blazing mode wherein this step is not executed. Emission generator 30 starts with element 1 and proceeds in ascending order through element N, successively computing emission values that are stored in the emission fragment and emission count registers within emission register 1 35 and emission register N 36. In particular, for each element, emission generator 30 forms an emission fragment, i.e. a portion of the element emission, by reading and modifying values stored in corresponding element descriptor which in turn specifies bits from MAE base key 34 wherefrom the fragment is formed. The “mono” base key is public. Using a public base key is a novel improvement: one that is vital for low latency encryption.

An alternate embodiment is to fill elements on demand. This differs from sequential filling as holdbacks would shuffle the fragment formation resulting in different xoring bits applied to the elements. However, the preferred embodiment is to fill sequentially. This is a software concession as it eliminates checking for initialization in the critical multiplexing loop. Albeit, a two loop implementation is possible with the second loop (without initialization checking) activated after all elements are initialized; but this is more complex. A hardware implementation is not impacted by sequential filling, and the latency introduced is minimal particularly if multiplexing is setup to wait when encountering an un-initialized element. This would permit multiplexing and element filling to start concurrently.

Amorphous stream generation now begins as holdback multiplexer 29 repetitively cycles through multiplexer slot 1 26 through multiplexer slot M 27. At each stage, one or more bits are extracted from the selected emission fragment register, subject to holdbacks defined by the corresponding multiplexer slot. The extracted bits are concatenated to form amorphous stream 38, which is sent to stream router 37. The values within emission register 1 35 and emission register N 36 are appropriately adjusted, including fragment refilling whenever the emission count is decremented to zero, wherein emission generator 30 is evoked to generate the next emission fragment, except for when the element emission is exhausted whereupon element recarver 17 is evoked to refill the proper element descriptor and emission register (and multiplexing slots except for accelerated mode). This process is also subject to block holdbacks wherein a block of multiplexer slots are skipped at selected intervals. Also, after a block holdback is processed, holdback multiplexer 29 retrieves from element recarver 17 two refill values that specify the next block holdback. Block holdbacks are a novel improvement.

Stream router 37 sends the initial portion of amorphous stream 38 to partition index manager 15 to provide the next partition index. The remainder of amorphous stream 38 is passed as keystream 39. After amorphous stream 38 is completely generated, partition index manager 15 carves the partition defined by the partition index just received. Using feedback as described, the process repeats until a keystream 39 of desired length is generated. Since elements are recarved when exhausted, amorphous stream generation could operate in a free running mode. However, the preferred embodiment is to employ feedback as described for partition recarving.

A variant operational mode is not to employ feedback. For this non-feedback mode, the entire amorphous stream is passed as the keystream. This is useful for applications that require only a small keystream. For these applications, the overhead of generating a next partition index can be eliminated.

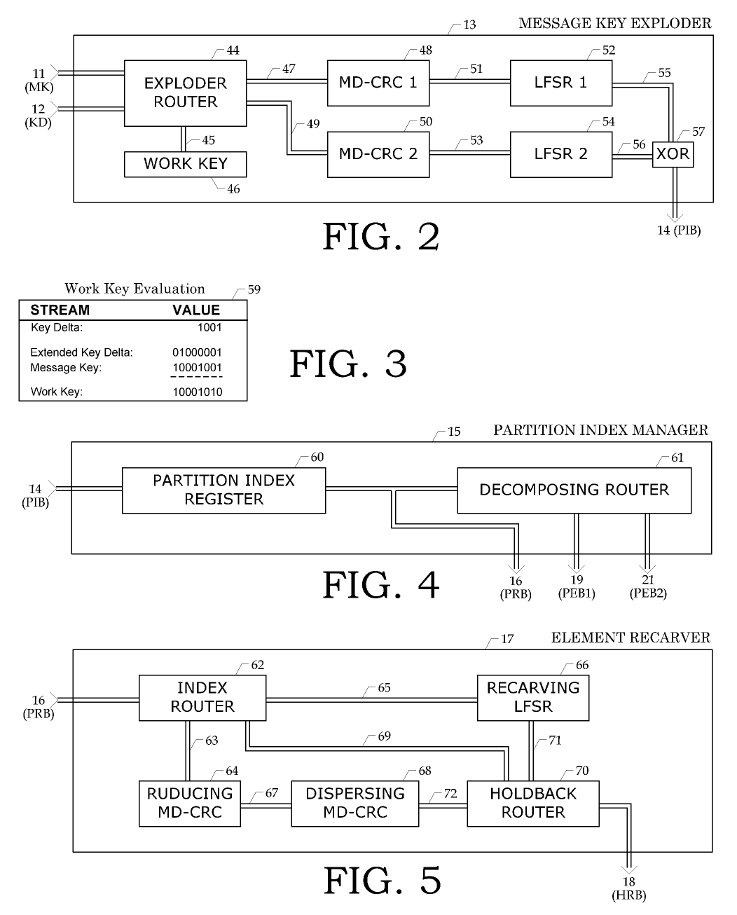

FIG. 2 illustrates the internal details of message key exploder 13. The message key exploder is founded on the simple exclusive-or combining function and a plurality of random sources, but it does contain the novel improvement of employing MD-CRC's for the hashing functionality. It operates as follows. Exploder router 44 receives message key 11 and key delta 12, and extends the smallest to the length of the other if necessary, and adds the adjusted values together with the result stored in work key 46. Streams are extended by padding with bits of value 0, injecting 0's after each source bit while forming the adjusted value. Typically, the sizes of message key 11 and key delta 12 are multiples of each other so the injection schedule is a simple proportion. But more complex schedules would be needed otherwise. The work key evaluation table 59 of FIG. 3 illustrates the arithmetic of a 4-bit key delta being added to an 8-bit message key.

Exploder router 44 then decomposes the value of work key 46 into two substrings that are sent to MD-CRC 1 48 and MD-CRC 2 50 for evaluation. Another hashing means such as MD5 could be used at this stage. But the preferred embodiment uses MD-CRCs because of their speed. Next, the respective MD-CRC results are sent to LFSR 1 52 and LFSR 2 54 as seed values. In general, any suitable random number generator could be used for 52 and 54, but LFSR's are a good choice. Subsequently, LFSR 1 52 and LFSR 2 54 both generate random streams that are sent to xor 57, which performs a bit-wise exclusive-or operation to form a partition index value that is outputted on partition index bus 14.

Exploder router 44 uses a substring length that is smaller than the MD-CRC size so that each substring value will likely expand into a unique random seed value. For example, a 512 bit substring is a good maximum length when expanding via a 640 bit MD-CRC. The preferred embodiment is to send the entire work key 46 as the substring to both MD-CRC's. This, together with two independent LFSR's, results in partition index generation that is suitably secure for the application. Note that the key delta should be a system generated random number to thwart differential crypto-analysis attempts and to ensure that a new partition index will be used.

Since partition indexes are of the order of 50,000 bits or more, key explosion would fall prey to correlation attacks. However, the chief purpose of the message key exploder is to provide a fast low latency process that yields a good mapping into a pool of random partition indexes. It is the amorphous process that is relied upon for cryptographic security. Therefore, even a single MD-CRC and corresponding LFSR could be used. However, the preferred embodiment comprises two or more MD-CRC and LFSR pairs.

One minor enhancement is to hash the substrings before sending them to the MD-CRC's. This would hinder attempts to manipulate a MD-CRC output by judicious choice of key delta values. This is a consideration in environments where an attacker can freely encrypt/decrypt data with their own key deltas, though not knowing the message key (albeit the keystream is still protected by the amorphous process itself). Any cryptographic hash that is relatively strong would suffice. The downside is the additional complexity for hardware implementations (and latency) as hash methods typically require math operations beyond addition.

Now, with a 640 bit MD-CRC, the maximum message key length is about 512 bits. To increase the key size, a larger MD-CRC and LFSR could be used. Alternatively, the first half of work key 45 could be sent to MD-CRC 1 48 with the second half to MD-CRC 2 50. This raises the maximum message key length to 1024 bits. Including a third pair of MD-CRC and LFSR units would increase the maximum to 1536 bits, and so forth. Another embodiment is to use a 1280 bit MD-CRC to feed two LFSR's. Alternatively, or in addition, the same substring could be sent to more than one MD-CRC's, or the substring extraction could inter-weave data from work key 45. In brief, within the details taught above, message key exploder 13 lends itself to simple extensions to support any message key of reasonable size.

A final note is that the key delta is often called a salt. The salt is typically appended to the message key with the entire stream then securely hashed to form the encryption key. However, message key exploder 13 uses simple addition, transforming the entire work key, which is particularly important whenever the work key is decomposed into separate substrings used per MD-CRC and LFSR chain.

The operation of partition index manager 15 as detailed in FIG. 4 operates as follows. The initial amorphous partition index from message key exploder 13 is sent along partition index bus 14, and is stored in partition index register 60. The contents of partition index register 60 are sent on partition recarver bus 16 to element recarver 17 for an initialization operation that will be described shortly.

Decomposing router 61 then decomposes a portion of partition index register 60 into N partition element specifiers with each element specifier corresponding to one of the N element descriptors. The decomposition details are mode specified and will be described in their proper place. Decomposing router 61 alternates sending an element specifier on partition extractor bus 1 19 to partition extractor 1 20 and sending an element specifier on partition extractor bus 2 21 to partition extractor 2 22. Only two partition extractors are illustrated. But the extraction process is fully parallel so addition extractor units could be implemented to further decrease the partition carving time. A software implementation could use an extractor for each available CPU.

Henceforth, amorphous stream generation begins with stream router 37 sending the initial portion of amorphous stream 38 on partition index bus 14 for storage in partition index register 60 as the next partition index.

Also during amorphous stream generation, decomposing router 61 will several times receive an element specifier from element recarver 17 via partition recarver bus 16. Decomposing router 61 sends each element specifier to its proper extractor, either partition extractor 1 20 and partition extractor 2 22, based on the element number.

Finally, after the amorphous stream is fully generated, stream router 37 signals decomposing router 61, which triggers partition carving as defined by the contents of partition index register 60. This feedback process repeats.

FIG. 5 illustrates the details of element recarver 17. As previously mentioned, besides element recarving, element recarver 17 performs certain initialization operations that are part of partition carving. These will be described first.

Each partition index is sent on partition recarver bus 16 to index router 62, which parses the entire partition index into contiguous portions, typically of equal length, typically byte aligned, with the last portion adjusted to account for any remainder. Index router 62 then successively sends each portion to reducing MD-CRC 64, which calculates a reduced value for each portion. Reducing MD-CRC 64 successively sends each reduced value to dispersing MD-CRC 68, which calculates a MD-CRC value called the dispersed seed. Dispersing MD-CRC 68 sends the dispersed seed to holdback router 70, which sends it on holdback recarver bus 18 to holdback multiplexer 29 who relays it to emission generator 30. In general, any hash function can be used for dispersed seed evaluation. But MD-CRC's are preferred because of speed. The dispersed seed and its evaluation means are both novel improvements.

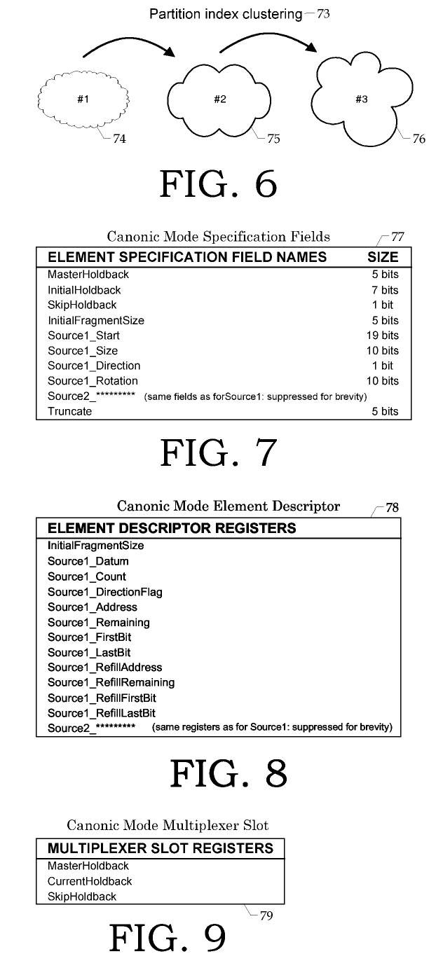

To understand the importance of dispersed seeds and how they reduce partition index clustering, consider the partition index clustering illustration 73 of FIG. 6. Cluster #1 74 denotes a set of partition indexes that vary in relatively few bit values. Cluster #2 75 represents the next partition indexes with respects to the indexes of Cluster #1 74. Assume that the prior invention's amorphous process is being used. Because a slight partition index change typically results in relatively few different bits between the corresponding next partition indexes, Cluster #2 75 is also a set of values that vary in relatively few bits. This grouping effect is propagated to the next generation of partition indexes as denotes by Cluster #3 76, and so on.

This results in similar partition index sequences whose keystreams are largely the same. These sequences will eventually diverge. But each sequence would be comprised of shorter chains with prominent clustering. The consequent is less variety in the keystreams and smaller cycle lengths before repetition begins (albeit the cycle length would almost always be extremely large). For a concrete example of de-clustering effect of the present invention, consider a 607 bit dispersed seed. For this, Cluster #1 will map into roughly 2⁶⁰⁷ different clusters, not one, thus greatly dispersing the chain of next partition indexes.

A final note regards the relative size of the partition index to the dispersed seed. Since a partition index is much larger than a dispersed seed, there will be a huge set of partition indexes that evaluate into the same dispersed seed value. However, this is not an issue because most of such partition index values will be largely different, which thus will already result in divergent next partition indexes. And for the infrequent case when this is otherwise, clustering that last for more than one generation will be extremely rare because of the dispersion provided by the hash.

The dispersed seed is an MD-CRC evaluation on the entire partition index. The preferred embodiment employs a two stage MD-CRC because the partition index and dispersed seed are relatively large. Without loss of generality, the following example will demonstrate the performance benefits of two stage evaluation.

The size of reducing MD-CRC 64 is 64 bits, while dispersing MD-CRC 68 has a size of 640 bits. Each partition index has 51,392 bits, which is decomposed into 10 portions, the first 9 portions have 5,136 bits each with the last portion having 5,168 bits. Then, 10 reduced values of size 64 bits are calculated from the 5,136 bit (and last) portions. Finally, the 640 bit dispersed seed is calculated from the reduced values, whose total length is 640 bits. The significance is that 640 bits verses 51,392 bits are evaluated by the 640 bit MD-CRC. For hardware, this isn't an issue. But for software, a 64 bit MD-CRC can be evaluated much faster than a 640 bit MD-CRC.

A minor implementation detail is that the preceding example assumes that the dispersed seed is actually 607 bits, not 640 bits. The point is that more bits should feed the dispersing MD-CRC than are extracted from it so that folding partition indexes into dispersed seeds does not produce excessive number of duplicate dispersed seeds.

In general, using a single dispersed seed is sufficient. But multiple dispersed seeds are possible with each being evaluated with an independent hash function on the entire partition index, with each dispersed seed then used to initialize a separate random source.

There are three more operations that element recarver 17 performs for the initialization associated with partition carving. First, index router 62 parses a contiguous set of bits from the received partition index, and sends them as a seed value to recarving LFSR 66. Secondly, index router 62 further parses the received partition into one or more predefined segments, depending on the mode, which are used as parsed seeds. Index router 62 sends the parsed seed(s) to holdback router 70, which routes them to emission generator 30 (except for accelerated mode wherein one of the parsed seeds is used by holdback multiplexer 29). Finally, recarving LFSR 66 is evoked to generate a sequence of block holdback bits that are sent to holdback router 70, which sends them to holdback multiplexer 29 via holdback recarver bus 18.

The primary function of element recarver 17 is described next; namely, to provide for the recarving of an element after its element emission is exhausted. This preserves the entropy of the amorphous process by maintaining a constant number of parameter bits that control amorphous stream generation. Recarving elements is a novel improvement.

An element exhausted signal containing the element index, sent on holdback recarver bus 18, is received by holdback router 70. This event triggers recarving LFSR 66 to generate recarving bits that define an element specifier. The element specifier and element index are sent to index router 62, which sends them on partition recarver bus 16 to partition index manager 15 to initiate recarving of the element.

The final function of element recarver 17 is to process refill block holdback requests. These requests, sent by holdback multiplexer 29, are received by holdback router 70, which signals recarving LFSR 66 to generate recarving bits for use as block holdback bits, with these bits routed back to holdback multiplexer 29.

One element recarving enhancement is to save the original element specifier on its corresponding element descriptor. The recarving bits are then xored with the stored values with the result used as the new element specifier. This preserves partition index entropy, though it does require more storage. One minor variant is to save the xored result back in the element descriptor's element specifier register(s). Another variant is to xor only part of the element specifier, but modifying all element specifier bits is preferred.

One additional element recarving enhancement is partial element recarving (the preceding recarving concepts are generally applicable to partial recarving as well). For partial element recarving, one or more elements are recarved after a predefined event. However, only a portion of each element is recarved. Which element portions could be randomly selected (e.g. recarve Source1 and the multiplexer slots registers for one element, but only recarve Source2 for the next element). All elements could be partially recarved at once but this would require extensive recarving bits and processing time. It is preferred that only a few elements are partially recarved after the predefined event, with block holdbacks being a good choice for the event.

The elements near the old and new current element with respects to a block holdback provide a convenient set of elements to partially recarve. But the preferred element set is those elements immediately preceding the new current element. Using this set would not halt multiplexing as the partial element recarving could be performed concurrently.

Partial element recarving does yield a richer amorphous process. But its complexity suggests it belongs with level 2 techniques.

4. Canonic Mode Keystream Generation

The parsing details for the canonic mode amorphous process are described next. Without loss of generality, a 64 KB MAE base key 34 will be partitioned into 512 elements (N=512) using a 53,952 bit partition index with each element having two independent sources. Elements with more than two sources are possible. But generally, two sources is the preferred size. (For a software implementation, the preferred memory management scheme is for the base key to be padded with additional bytes, their number equaling the maximum source size. These additional bytes are filled using the initial portion of the base key, and provide for automatic address wrapping without having to check address pointers. Alternatively, the padding bytes could be included within the 64 KB size, which reducing the effective base key size but keeps the base key compact.)

For canonic mode, there is one multiplexer slot per element descriptor. Hence, there are 512 multiplexer slots (M=N=512). The element specifiers are consecutively mapped at the beginning of the partition index, followed by 608 bits used as a recarving seed, and followed by another 608 bits used as a parsed seed. Each element specifier is comprised of 103 bits, which is further decomposed into specification fields as defined in the canonic mode specification fields table 77 of FIG. 7.

As each element specifier is evaluated, the values are stored in the corresponding element descriptor and multiplexer slot, whose internal register compositions are respectively defined in the canonic mode element descriptor table 78 of FIG. 8 and in the canonic mode multiplexer slot table 79 of FIG. 9. Note: At times, the source registers are referenced generically, e.g. Source_Datum. In such cases, the context will provide which source (1 or 2) is to be used.

The specification evaluation as exemplified by partition extractor 1 20 is as follows. Herein, the bits for each specification field are interpreted as an unsigned integer value. Also, modular arithmetic is used for bit address calculations, which may result in an address wrapping.

The MasterHoldback specification field (5 bits) value is added to a base value, 40 in this example, with the sum being the evaluation result (with range 40 to 71). This result is stored in the MasterHoldback register of the multiplexer slot.

Next, the InitialHoldback specification field (7 bits) value is multiplied times the MasterHoldback register value minus 1. That product is shifted to the right 7 bits, and then incremented to form the evaluation result (with range 1 to 71), which is stored in the multiplexer slot's CurrentHoldback register. The SkipHoldback specification field (1 bit) value is then incremented with the evaluation result (with range 1 to 2) stored in the multiplexer slot's SkipHoldback register. The InitialHoldback evaluation means is novel improvement.

The InitialFragmentSize specification field (5 bits) value, whose range is 0 to 31, is stored in the InitialFragmentSize element descriptor register. The InitialFragmentSize, used to eliminate emission fragment refill accumulation, is a novel improvement.

The Source1 specification fields are evaluated next. The Source1_Start specification field value is used as a bit address within MAE base key 34, which defines a uniform random address since a 19 bit value spans the entire base key exactly. The Source1_Size specification field (10 bits) value is added to a base value, 128 in this example, with the sum defining the source size (with range 128 to 1151). These values define a source, which is a contiguous block of base key bits, where the bit address defines the first bit of the source and where the last source bit is at bit address plus source size minus one.

Next, the Source1_Direction specification field (1 bit) value is used to determine the extraction direction: 0 means ascending extraction (from first bit to last bit), 1 means descending extraction (from last bit to first bit). This value is stored in the Source1_DirectionFlag register. The ascending case will be described here (the descending case is similar). The Source1_Rotation specification field (10 bits) value is added to the first bit address to derive the starting bit address. The source stream is defined as the starting bit through the last source bit, and then from the first bit to the last bit with this last stage repeating as necessary.

The source stream is extracted a word at a time. Thus, the first and last words may contain non-source bits. In this example, there are 32 bits per word. The source stream parameters are used to initialize the following element descriptor registers. Source1_Address receives the word address of the starting bit. Source1_Remaining receives the number of words from the starting bit to the last bit. Source1_FirstBit receives the bit position of the first source bit in the starting bit word. Source1_LastBit receives the bit position of the last source bit in the last bit word. The refill registers (Source1_RefillAddress, Source1_RefillRemaining, Source1_RefillFirstBit, Source1_RefillLastBit) are similarly initialized, but based on the first and last bit rather than the starting and last bit.

The two remaining source related element descriptor registers are described next. Source1_Datum holds the current source stream word, while Source1_Count holds the number of remaining source bits in Source1_Datum. Source1_Count is initialized to 0 by partition carving. Source1_Datum is filled by emission generation, not partition carving. A final point is that the source related element descriptor registers, here Source1_Datum through Source1_RefillLastBit, are collectively known as a source controller.

The Source2 specification fields are then similarly evaluated to fill the second source controller. Finally, the Truncate specification field (5 bits) value is used to evaluate the element emission size, which is the size of source 1 and source 2 added together minus the truncate value. The element emission size value is stored in the appropriate emission remaining register as previously described.

Independent sources and their independent rotations are novel improvements. Random start addresses are also a novel improvement. These are the key mapping improvements that permit parallel partition carving, wherein permuting elements is replaced with a stronger system of element combinations.

An alternate approach to evaluate the initial CurrentHoldback value would be to use the modulus of the InitialHoldback specification value with respects to the MasterHoldback value. Here, at most three compare/subtraction operations are needed. This eliminates the multiplication, but it does introduce a bias. The bias could be minimized by using the reflection technique used in calculating the permutated indexes of the prior invention. As such, this is a viable approach.

However, the preferred embodiment is the multiplication method so that there is no bias. On a modern CPU, integer multiplication is quite fast, though requiring multiplication does introduce a hardware implementation burden. But this is minor. A standard multiplication unit is one possibility. But if that isn't fast enough, a flash multiplier is practical as the input range is fairly small so that only a 3.5 KB lookup table is needed (128*32*7/8/1024). Furthermore, a single lookup table should be sharable among several partition extractors without introducing a bottleneck.

It is also possible to remove the holdback specification fields from the element specifier and place them contiguously in their own section within the partition index as their evaluation is independent of the other element specification fields. However, this doesn't introduce any new opportunities for parallel computation, and it does introduce another loop for software implementations. Thus, the preferred mapping is to embed the holdback specification fields within the element specifier.

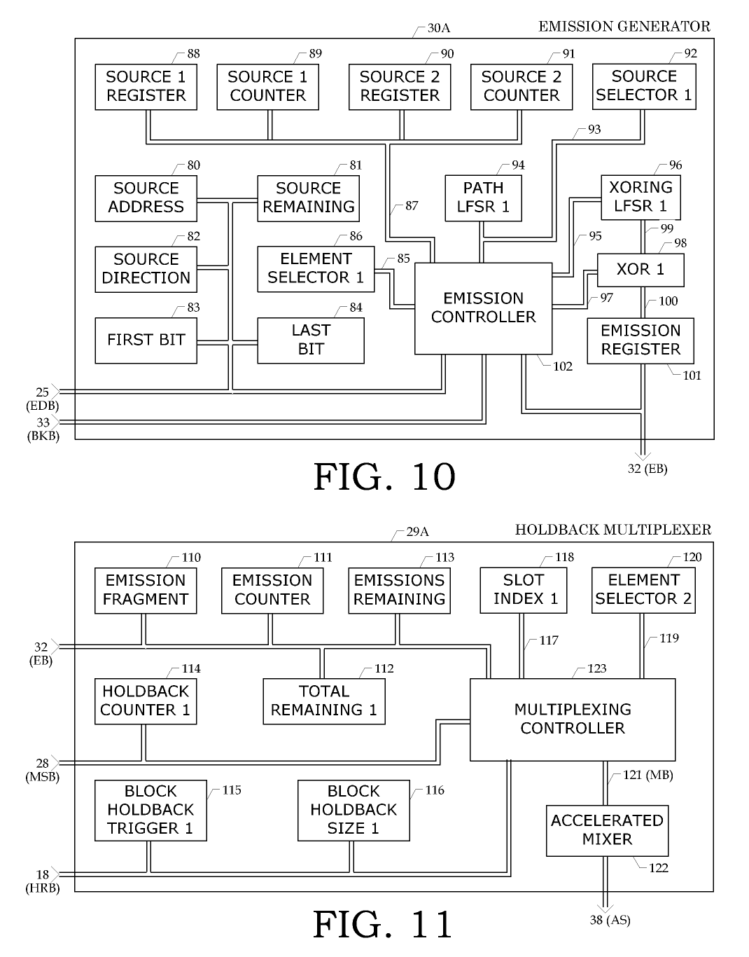

Next described are the details for canonic mode emission generation as illustrated by emission generator 30A of FIG. 10. Most of the registers and counters within emission generator 30A have corresponding registers within an element descriptor. But a means is needed to select a specific element descriptor from among element descriptor 1 23 through element descriptor N 24; and further, a means is needed to select a specific source within the selected element descriptor. Element selector 1 86 and source selector 1 92 are used for this purpose. For brevity, terms such as selected registers or corresponding registers will be used to denote this relationship. Also, element selector 1 86 is used to select an emission register among emission register 1 35 through emission register N 36.

As each partition is carved, emission generator 30A needs to perform two initialization steps. The first is to receive the parsed seed from element recarver 17. The parsed seed is routed via emission bus 32 to emission controller 102, which sends it to path LFSR 1 94 to initialize it. For this example, one parsed seed is used wherein path LFSR 1 94 generates bits using a single LFSR. But multiple LFSR's are possible, each receiving their own parsed seed, wherein the generated path bits would be alternately taken from the plurality of LFSR's. This has particular usefulness for a huge amorphous process, e.g. one with a million bit partition index.

The second initialization step is to receive the dispersed seed, again via emission bus 32, which emission controller 102 sends to xoring LFSR 1 96 to initialize it. Again, a single LFSR is used for the bit generator. But the same generalization as with the path bits is applicable, though the approach of applying a single dispersed seed to other seeds, as exemplified in the blazing mode path means later described, is preferred as it eliminates the need for a larger dispersing MD-CRC.

Note that the dispersed seed drives the xoring bit generation. Hence, the dispersed seed substantially randomizes all element emissions. This is the final stage of the novel improvement for reducing partition index clustering. Now the dispersed seed could instead be applied to the path LFSR, which would result in the same de-clustering effect. Alternatively, two dispersed seeds could be evaluated using different MD-CRC's. This would provide even greater reduction of clustering. However, a single dispersed seed is preferred as the MD-CRC evaluation costs outweigh the additional de-clustering benefit.

The emission fragment generation means is described next. This begins with element selector 1 86 being set to a value. Subsequently, emission controller 102 initializes source selector 1 92 to index the first source, and then successively loads each set of source section registers, incrementing source selector 1 92 as it proceeds. The source1 section consists of source 1 register 88 and source 1 counter 89, which are respectively filled with the values from the Source1_Datum and Source1_Count registers of the selected element descriptor, where the values are send on element descriptor bus 25 through emission controller 102.

After loading the source sections, emission controller 102 fills emission register 101 with the emission fragment by repetitively generating a bit as follows. One bit is retrieved from path LFSR 1 94 and is used to “randomly” fill source selector 1 92, which selects a source section, here assumed to be source 2 for a path bit of value 1. Subsequently, a source bit is shifted out of source 2 register 90 and source 2 counter 91 is decremented. In conjunction, a substitution bit is retrieved from xoring LFSR 1 96. Both the source bit and substitution bit are sent to xor 1 98 with the result bit shifted into emission register 101. This process repeats, subject to source refills, until an emission fragment is generated whereupon the contents of the source section registers are stored back into the corresponding element descriptor registers. There is one additional step to emission fragment generation concerning the InitialFragmentSize (only used when an element is first carved), which is described later. Finally, the contents of emission register 101 are sent via emission bus 32 and stored in the fragment portion of the selected emission register, with the emission register's count portion initialized to the number of emission fragment bits.

Emission controller 102 refills a source register when its corresponding source counter is zero. This occurs when the first emission fragment is generated for each element because the backing descriptor register, Source_Count, was initialized to 0 by partition carving. A source refill also occurs each time a source counter is decremented to 0. The details of the source refill process are described next.

A source refill begins by loading source remaining 81 and source direction 82 from the selected element descriptor registers of Source_Remaining and Source_DirectionFlag, respectively.

If source remaining 81 is non-zero, source address 80 is filled from the corresponding Source_Address register. Otherwise, a source address refill occurs wherein source address 80 is filled from Source_RefillAddress register; and additionally, source remaining 81, first bit 83 and last bit 84 are filled from Source_RefillRemaining, Source_RefillFirstBit and Source_RefillLastBit, respectively; with the value of last bit 84 then stored into the Source_LastBit register.

After source address 80 is loaded, it is used to read a word from MAE base key 34 via base key bus 33 with the word value then stored in the selected source register. If a source address refill occurred, the source register is shifting by the number in first bit 83 so as to trim the leading bits. Subsequently, source address 80 is either incremented or decremented based on source direction 82, with source remaining 81 then decremented.

The selected source counter is then initialized to the number of bits in the source register. If a source address refill occurred, the value of first bit 83 is subtracted from the source counter. If source remaining 81 was decremented to zero, the number of trailing bits is subtracted from the source counter. The trailing bits are the non-source bits in the last source word, whose count is derived from last bit 84, which is filled from the selected Source_LastBit register prior to calculating the count.

The final step of a source refill is to store the contents of source address 80 and source remaining 81 into their corresponding element descriptor registers. This completes the description of generating an emission fragment.

Emission fragments are generated in three circumstances. The first is the priming step as previously described at the beginning of Detailed Description section. To elaborate, emission controller 102 sets element selector 1 86 to index the first element, and then generates and stores an emission fragment into emission register 1 35, as well as setting the count. Subsequently, emission controller 102 increments element selector 1 86, and fills the next element, and so on until all N elements are filled.

The second is circumstance is after an element is recarved. Here, the emission fragment and its corresponding count are filled immediately after the element is recarved.

During priming and when recarving elements, the InitialFragmentSize is also used to generate emission fragments. In particular, after emission register 101 is filled, emission controller 102 reads the InitialFragmentSize value from corresponding element descriptor and determines a shift count. The shift count is set to the emission fragment bit size minus the InitialFragmentSize. The bits in emission register 101 are then shifted by shift count. In addition, the value for emission register's count portion is also adjusted to reflect the discarded bits.

The final circumstance when emission fragments are generated is when fragments are exhausted. This occurs when holdback multiplexer 29 emits the last bit of an emission fragment. When the last bit is emitted, holdback multiplexer 29 sends the appropriate element index via emission bus 32 to emission controller 102, which stores it in element selector 1 86 with the fragment then generated and stored as previously described.

The benefits provided by the initial fragment size specification are twofold. First, the element fragment counts are randomized. Note that during multiplexing, elements are chiefly accessed sequentially. If the fragment size is initially the same for all elements, after a fixed number of multiplexing operations the elements will tend to require refill requests, one after another. This is referred to as emission fragment refill accumulation. Refill accumulation degrades the keystream generation rate because emission fragment generation is a largely a serial process. For maximum throughput, multiplexing and fragment generation need to run simultaneously, without long halts from the multiplexer waiting for an emission fragment. The randomization provided by initial fragment sizes eliminates refill accumulation together with its poor performance.

The other benefit provided by the initial fragment size specification is that the substitution bits used to form emission fragments are retrieved in an essentially permuted order. Namely, as the element refills are randomized, so is the retrieval of substitution bits from the random source. Specifically, viewing the emission fragments as sequentially ordered for multiplexing, the substitution bits applied to those fragments have been permutated with fragment size level granularity. Randomized usage of substitution bits thwarts correlation attacks against the random source, which is of particular importance when the random source is a LFSR.

However, the problem of non-randomized substitution bit usage still exists when the element fragments are generated during priming. This will be manifested in the initial portion of the amorphous stream. When using feedback, these “non-randomized” bits are contained within the next partition index. Hence, the actual keystream is free from this problem, but not so when operating in a non-feedback mode.

Regarding a non-feedback mode system, if the keystream length is small enough, the correlation threat can safely be ignored. Otherwise, one way to address the problem is to directly permute the substitution bits. For efficiency, the random source could be permuted with fragment size level granularity. Even a small frame size of say permuting 4 words at a time would significantly mitigate the correlation threat.

There is one final detail regarding the initial fragment size specification. The preferred embodiment as described above is to generate the full emission fragment and then discard bits based on the initial fragment size. This has the advantage of utilizing a uniform number of path and substitution bits for each element, which simplifies software implementations. An alternative embodiment is to only generate the exact number of emission fragment bits needed. This alternative embodiment is slightly faster, but its complexity makes it less attractive.

Using multiple emission generators for parallel processing is possible. For example, the dependent units, path LFSR 1 94 and xoring LFSR 1 96, could be shared by two emission generators constrained by serial access. But outside of potentially reducing latency during the priming step, it would only be useful if emission generation is the bottleneck verses multiplexing.

It is noteworthy that the emission fragment width is not arbitrary. 32 bit fragments will yield a different keystream than 64 bit fragments because of the different usage of the path and xoring bits. This is an interesting point as CPU's are evolving from 32 to 64 bit machines. A larger width is advantageous with respects to generation speed. But an LFSR's output is predictable if twice its register length is known. Thus, fewer elements are spanned with a non-predicable length as the fragment width increases. So from a cryptographic standpoint, with 512 elements and 607 bit LFSR's, a 32 bit emission fragment width is preferred over a 64 bit width.

The enhancement of using multiple LFSR's for path bit and xoring bit generation was mentioned earlier, noting its utility for huge amorphous processes. But this enhancement is also pertinent in regards to emission fragment width. Specifically, the bit streams from multiple LFSR's are multiplexed together to form a single stream, say by retrieving the number bits in an emission fragment successively from each LFSR. Hence, the cryptographic strength of the prior example can be achieved by using two 607 bit LFSR's and a 64 bit fragment width.

The details for canonic mode amorphous stream generation as performed by holdback multiplexer 29A of FIG. 11 are described next. There are three initialization steps that are performed for each partition carving. The first is to fill total remaining 1 112, which occurs in conjunction with the emission sizes being sent to the emission registers from the partition extractors. As the emission sizes are routed on emission bus 32, multiplexing controller 123 reads the value for each element and adds them together with the sum stored in total remaining 1 112.

The second initialization step is to fill the block holdback values. As described earlier, element recarver 17 generates a sequence of block holdback bits that are sent via holdback recarver bus 18. These bits are received by multiplexing controller 123, which splits them into two sequences, each interpreted as an unsigned integer, thus defining a skip value and a trigger value. The skip value is stored in block holdback size 1 116, which denotes the number of multiplexing slots to skip for the next block holdback. A constant is added to the trigger value with the sum stored in block holdback trigger 1 115, which denotes the number of bits to emit before the block holdback occurs.

The final initialization step is to fill slot index 1 118 so it selects the first multiplexer slot, namely multiplexer slot 1 26.

Subsequently, the amorphous stream is generated by repetitively cycling through the multiplexing slots as follows. Multiplexing controller 123 uses slot index 1 118 to select a multiplexer slot from which the CurrentHoldback register is read with the value stored in holdback counter 1 114, which is then decremented.

If holdback counter 1 114 is decremented to zero, a holdback occurs wherein multiplexing controller 123 reads the MasterHoldback register from the selected multiplexer slot, and stores the value in the corresponding CurrentHoldback register. The SkipHoldback register is also read with its value added to slot index 1 118, subjected to wrapping, which advances the index to select the next multiplexer slot to be processed.

If holdback counter 1 114 is non-zero after being decremented, its contents are stored backed to the CurrentHoldback register and an emission occurs. The emission begins by copying slot index 1 118 into element selector 2 120. Multiplexing controller 123 then reads the fragment, count and remaining registers from the emission register selected by element selector 2 120, and stores the values in emission fragment 110, emission counter 111, emissions remaining 113, respectively. Emission fragment 110, a shift register, is then pulsed with the shifted bit sent as the next amorphous stream 38 bit. (Accelerated mixer 122 is not used for canonic mode.) Subsequently, total remaining 1 112 is decremented. If decremented to zero, amorphous stream generation is complete whereupon multiplexing controller 123 signals partition index manager 15 to carve a new partition. Otherwise, emission counter 111 is decremented and emissions remaining 113 is decremented.

If emissions remaining 113 is zero after being decremented, the selected element is recarved by sending an element exhausted signal to element recarver 17 using the value of element selector 2 120 for the element index. This results in the selected element descriptor and emission register to be filled along with the multiplexing slot.

If emissions remaining 113 is non-zero after being decremented, its contents are stored back to the corresponding emission remaining register. Further, if emission counter 111 is non-zero, emission fragment 110 and emission counter 111 are stored back to the corresponding emission fragment and emission count registers; otherwise, multiplexing controller 123 sends the contents of element selector 2 120 via emission bus 32 to emission generator 30A, which generates the next emission fragment resulting in the corresponding emission fragment and emission count register being refilled.

After each emission, block holdback trigger 1 115 is decremented. If this trigger is still non-zero, slot index 1 118 is incremented, subject to wrapping, so as to select to the next multiplexing slot. When block holdback trigger 1 115 is decremented to zero, a block holdback occurs wherein multiplexing controller 123 advances slot index 1 118 by the number specified by block holdback size 1 116. A block holdback further comprises sending a refill block holdback request to element recarver 17, which sends a sequence of bits to multiplexing controller 123 that are used to refill block holdback trigger 1 115 and block holdback size 1 116 in the same manner as previously described for their initialization. In accord with the example numbers given, the trigger value is 7 bits wide with a base trigger of 400, yielding a holdback trigger range of 400 to 527. The skip value is 6 bits wide for a block holdback size range of 1 to 64. Alternatively, a 9 bit wide skip value is a good choice as that would inject block holdbacks that span the entire element space. As previously mentioned, block holdbacks are a novel improvement.

4A. Canonic Mode Enhancements

The details for two techniques to reduce element adjacency are now described. While applicable to accelerated mode as well, they are more appropriate for canonic mode. In brief, most successive bits from the multiplexer are from successive element emissions. Thus, it is advantageous to minimize the element emission length to prevent correlation attacks based on element adjacency.

The first novel improvement that reduces element adjacency is called assigned sources. In the prior embodiment, each element had two fixed sources. Assigned sources consist of a pool of sources.

Each element is assigned to one or more sources (typically two) from the pool, but periodically the sources are reassigned. The result is element emissions with constantly changing sources, which in effect, permutes the elements.

Sources are defined as before with each source derived from a set of source specification fields. The difference is that before these specification fields were associated to elements, but now they are associated to the pool. The preferred pool size equals the number of sources per element times the element count, which will be called one-to-one pool size. However, smaller or larger pools are possible. Smaller pools require less partition index bits, and larger pools require more. In general, larger pools are desirable because of their higher entropy. But at some point, adding more sources is prohibitive because of partition index size.

With assigned sources, partition carving now includes providing each element with its initial source assignment(s). With a one-to-one pool size, the preferred initialization is the sequential assignment of the pool sources to the elements, though other fixed patterns are possible. Since the sources are random already, randomizing the assignment is superfluous. Yet, random initialization does provide a larger source assignment space whenever sources can be assigned to multiple elements. And for a parallelizable random initialization means that is fast and simple, permitting multiple source assignment is necessary. However, the partition index bits needed for randomization also introduces redundant representations of the same effective source assignments, rendering random initialization an unwarranted complexity for a one-to-one pool size.

For a larger pool size (e.g. twice the one-to-one pool size), a random initial source assignment has distinct value, though sequential assignment of the leading pool sources is still sufficient. For a smaller pool, the preferred initialization is sequential assignment until the pool is exhausted. The sources for remaining elements could be assigned by starting over with the first pool source, but a random initialization of the remaining elements is preferred.

When initializing source assignment randomly, the preferred means to select a source is to derive a source index that maps into the source pool. Thus, pool sizes that are a power of two are preferred because deriving indexes is simpler. The preferred supply of the source index bits is some random source that is seeded via a partition index specification field. The initialization step can run concurrently with partition index carving, hence not adding latency. Alternatively, the source indexes can be carved directly from the partition index. The downside is size: 10,240 bits are needed for a 512 element embodiment. In addition, source index collision resolution (soon to be described) could also be applied.

Once keystream generation begins, the sources are periodically reassigned. An element is assigned a new source by deriving a source index with the corresponding pool source assigned to it. Typically, all sources for an element are reassigned at once.

With multiple sources per element, a source could be multiply assigned within an element. This is not a serious problem as the source bits for each element source would come from a different part of the common source. Yet, this does give rise to element emissions generated from same source. Hence, the preferred mode is to prevent same source assignments by detecting collisions and adjusting the source indexes so they no longer collide. Collisions are detected by comparing the source indexes. The preferred adjustment is to increment one of the indexes (and doubly increment the second index if three indexes collide, and so on). Alternatively, a collision could be resolved by deriving another source index and trying again until the indexes are unique. However, this is of modest value as collisions are relatively rare.

When deriving source indexes used for source reassignment, the simplest means is using successive bits from a random source seeded via a partition index specification field. Alternatively, each source per each element could be associated to its own assignment register, with the assignment registers initialized during partition carving via assignment specification fields. Here, a source index is derived by starting with bits from a random source and then xoring them with the corresponding assignment register value to form the source index. In addition, the source index value could optionally be stored as the new assignment register value. Note that the width of the assignment register could be smaller than the source index width, which typically is the case so as to minimize the assignment specification fields bits allocated in the partition index.

What remains to describe is when source reassignment occurs and to which sources. One mode of operation is to reassign all element sources at once, every time a certain event occurs. The preferred event is when a countdown register is decremented to zero. Decrementing the countdown register after each block holdback is the preferred time because block holdbacks are sufficiently frequent, and this method is efficient in software. The countdown register is initialized after the initial partition carving, initialized when decremented to zero, and typically initialized again after each subsequent partition carving. The countdown register could be initialized with a fixed value, or alternatively, initialized to a random value that is bounded within a range.

If the countdown value is too high, multiple emission fragments will be generated from the same sources. If the countdown value is too low, wasteful source reassignment will occur with many elements being assigned sources that are never used. An optimal value can be determined, but it will be statistical in nature encompassing the entire element collection.

A more refined mode of operation is to reassign an element's sources immediately before its emission fragment registered is refilled. This ensures that every emission fragment is generated with a new set of sources. In addition, assigned sources will typically be implemented as separate entities outside of the element descriptors. Here, no source bits are jettisoned for any part of emission fragment formation.

A minor enhancement is the operational mode wherein a source is reassigned immediately before the source's datum register is refilled. This mode slightly shortens the correlation window by switching sources more often. Other modes of operation are possible wherein a partial set of sources are reassigned, but these are of lesser interest.

In regards to recarving elements, there are two main strategies. The first is to randomly assign new sources to the newly carved element while leaving the sources themselves intact. Since sources emit a repeating stream, they don't need to be recarved and their constant reassignment eliminates any concern stemming from their periodic nature. However, the more robust strategy is to recarve sources as part of element recarving. One possibility is to recarve the sources that were previously assigned to the element. But the more nature choice is to recarve the sources that were just assigned to the recarved element.

A final note is the software performance (single CPU) when employing assigned sources. At first glance, this may appear to be a level 2 technique. However, there is only a 3% slowdown when using the all element sources reassignment mode of operation. Thus, assigned sources are suitable for a level 1 implementation, though certain features such as using wide assignment registers encroaches level 2 territory.

The second novel improvement that reduces element adjacency is called dynamic sources. With dynamic sources, elements contain sources whose source related specification fields are evaluated as before. The difference is their source size is very small: the optimum size being half of the emission fragment width. When a source is exhausted, a random means is used to refill it. Dynamic sources provide the same benefit as assigned sources (i.e. essentially permuting the elements), but the effective source pool is much larger.

A minor enhancement is to refill all sources on an element whenever one of its sources is exhausted. This is efficient as an element's sources tend to exhaust at the same time. This also injects some entropy into the emission fragment generation process.

For dynamic sources, the source size specification field has limited value. The canonic mode example above, which uses 10 bit specification fields, has source sizes ranging from 128 to 1151. For dynamic sources, a practical source size range is 15 to 18, based on a 2 bit specification field. With such a small range, using a constant for the source size is a reasonable choice. And on a typical CPU, a fixed source size (16 in this example) has the additional benefit of simplifying source rotation specification field evaluation.

A final note regarding source size pertains to calculating a partition's amorphous stream length. Previously, this length was the total of the element emission lengths. But since an element emission is now reduced to an emission fragment, a new calculation means is needed. While a constant could be used, the preferred means is to define an amorphous length specification field on the partition index that is used to derive a random value with an appropriate range.

Refilling sources is described next. One method is to use a random source to generate the source specification fields, which are then evaluated into a source.

However, a better source refill method is to save the original source specification field values on each corresponding element descriptor. A random source is then used to generate bits that are xored with the stored values. The source is then evaluated from the xored result. This method has the benefit of preserving element entropy. Again, a minor variant is to save the xored result in the element descriptor registers that hold the source specification field values. Another variant is to xor only part of the source specification field values, with modifying the source start specification being the most important.

In conclusion, dynamic sources reduce element adjacency better than assigned sources. But dynamic sources do require more processing power to generate the random bits and to refill the sources, rendering this a level 2 technique.

5. Accelerated Mode Keystream Generation

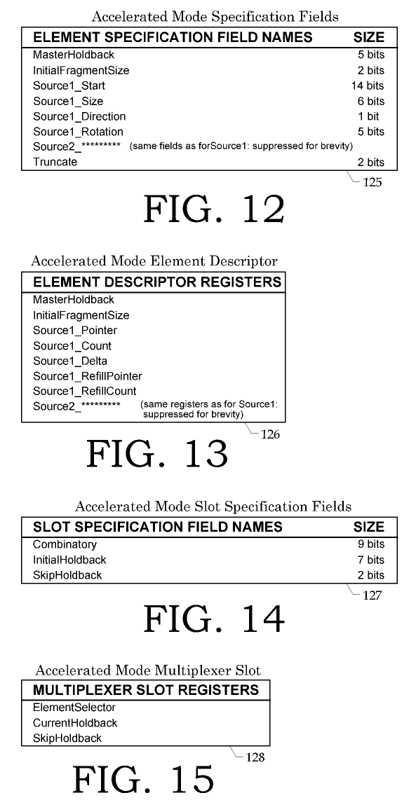

The parsing details for the accelerated mode amorphous process are described next. Again, without loss of generality, a 64 KB MAE base key 34 will be partitioned into 512 elements (N=512). The partition index size for the accelerated mode machine being presented is 69,920 bits, each element has two independent sources and there are four multiplexer slots per element descriptor for a total of 2048 multiplexer slots (M=2048). The element specifiers are consecutively mapped at the beginning of the partition index, directly followed by the slot specifiers, also consecutively mapped. Then comes 608 bits used as a recarving seed, followed by another 608 bits used as a parsed seed, and finally another 608 bits used as a parsed seed for accelerated mixer 122. Each element specifier is comprised of 61 bits and each slot specifier consists of 18 bits. Each element specifier is further decomposed into specification fields as defined in the accelerated mode specification fields table 125 of FIG. 12. As each element specifier is evaluated, the values are stored in the corresponding element descriptor whose internal register compositions are defined in the accelerated mode element descriptor table 126 of FIG. 13.

The element specification evaluation for accelerated mode as exemplified by partition extractor 1 20 is next described. Many parts are the same or similar to canonic mode evaluation so only the differences will be described.

The MasterHoldback evaluation is the same as canonic except the result is now stored in the element descriptor. The Source1 specification fields are then evaluated. The Source1_Start specification field value again defines a uniform random address within MAE base key 34, but the address is word aligned based on 32 bit words. Namely, the start specification value is left shifted two bits to form the address. Similarly, the Source1_Size specification field (6 bits) value is added to a base value (8) with the sum defining the source size (with range 8 to 71 words). The start and size values define a source, which here is a contiguous block of base key words.

As before, the Source1_Direction specification field determines the extraction direction, which results in Source1_Delta being set to 4 for ascending and −4 for descending (4 yields word advancement since 4 bytes is 32 bits). As with canonic, only the ascending case will be described. The Source1_Rotation specification field (5 bits) value is left shifted twice and then added to the first word address to derive the starting word address (subject to wrapping within the source). The source stream is the starting word through the last source word, then from the first word to the last word, repeating the last stage as necessary.

The starting word address is stored in Source1_Pointer. The number of words from the starting to the last word is stored in Source1_Count. Finally, the first word address is stored in the Source1_RefillPointer register with the source size stored in Source1_RefillCount.

The Source2 specification fields are then similarly evaluated to fill the second source controller; namely the Source2 element descriptor registers. Finally, the Truncate specification field (2 bits) value is used to evaluate the emission word size, which is the size of source 1 and source 2 summed together minus the truncate value. The emission word size is multiplied by 32 to form the element emission size, which is stored in the appropriate emission remaining register.

The multiplexer slots are described next. The decomposition of a slot specifier to its specification fields is defined in the accelerated mode slot specification fields table 127 of FIG. 14, whose evaluated values are stored in the corresponding multiplexer slot, the internal register being defined in the accelerated mode multiplexer slot table 128 of FIG. 15.

All of the element specifiers must be evaluated before any slot specifier because a slot depends on the MasterHoldback value stored in a randomly selected element. The evaluation of a slot specifier begins by incrementing the Combinatory specification field (9 bits) value and storing it the ElementSelector register. The MasterHoldback value from the selected element descriptor is then retrieved. The InitialHoldback and SkipHoldback specification fields are then used to fill the CurrentHoldback and SkipHoldback registers as described for canonic mode (except the skip holdback range is now 1 to 4 as that specification field is now 2 bits). The random element selection as provided by the combinatory specification is a novel improvement.

The configuration of multiple multiplexing slots per element is similar to what was called “chained” multiplexing in the inventor's prior patent. But chained multiplexing was based on a permutation of the elements. Hence, its partition evaluation is non-parallelizable, unlike what the combinatory specification provides.

However, the multiplexer slot evaluation described above does introduce a piecemeal parallelizability. Namely, the element specifiers and the slot specifier can both be evaluated by a parallel process, but the element specifiers must be evaluated first. Since accelerated mode is geared towards software, this isn't a serious constraint. Yet, the infracting dependency can easily be eliminated.

The solution is to evaluate the InitialHoldback specificiation field independently from the master holdback value. This would introduce initial holdback values that could go beyond the MasterHoldback value that is eventually associated to the multiplexer slot. But this would be a minor concession if fully parallelizable evaluation was desired.

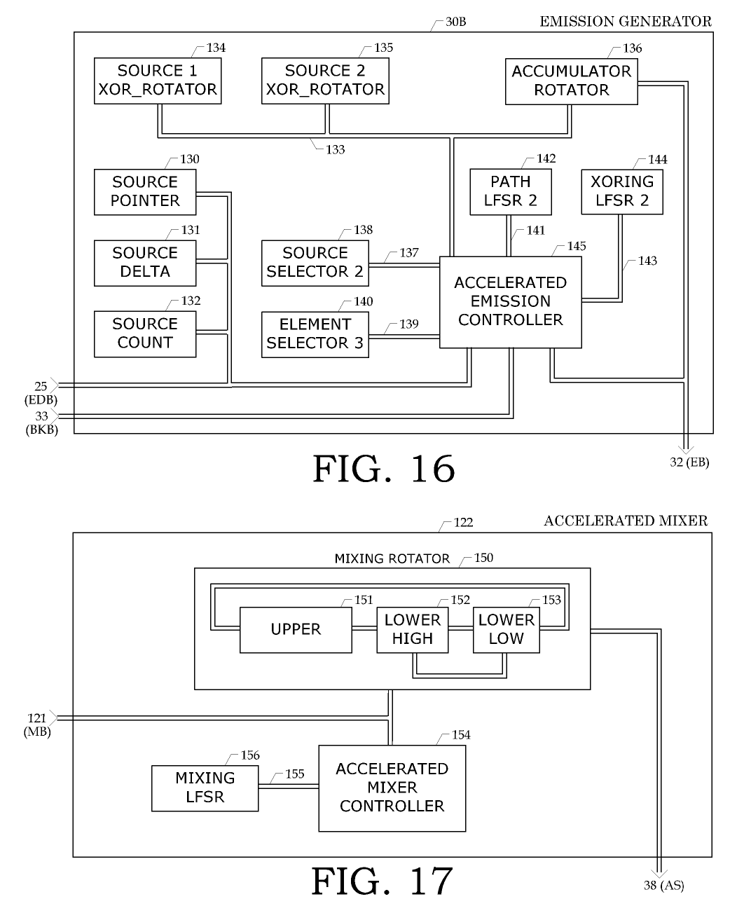

The details for accelerated mode emission generation as illustrated by emission generator 30B of FIG. 16 are described next. Several aspects are the same as the canonic mode version. For example, element selector 3 140 and source selector 2 138 are used for selecting a specific source within a selected element descriptor. Also, the source retrieval registers of source pointer 130, source delta 131 and source count 132 have a corresponding register within an element descriptor, namely Source_Pointer, Source_Count and Source_Delta.

As each partition is carved, emission generator 30B needs to perform two initialization steps. The first is to receive the parsed seed from element recarver 17. The parsed seed is routed via emission bus 32 to accelerated emission controller 145, which sends it to path LFSR 2 142. The other initialization step is to receive the dispersed seed, again via emission bus 32, which accelerated emission controller 145 sends to xoring LFSR 2 144. As with canonic mode, both units can be generalization to use with multiple LFSR's.

Emission fragment generation is described next, which begins with element selector 3 140 being set to a value. Then accelerated emission controller 145 initializes source selector 2 138 to index the first source.

Subsequently, source pointer 130, source delta 131 and source count 132 are loaded from their corresponding element descriptor registers. The word addressed by source pointer 130 is read from MAE base key 34 using base key bus 33, and is stored in source 1 xor rotator 134. Source delta 131 is then added to source pointer 130 and source count 132 is decremented. If source count 132 is decremented to zero, source pointer 130 and source count 132 are filled with the values from the selected Source_RefillPointer and Source_RefillCount registers. Finally, the contents of source pointer 130 and source count 132 are stored back to their corresponding element descriptor registers.

Accelerated emission controller 145 then increments source selector 2 138 and repeats the above process, which results in source 2 xor rotator 135 being filled.

Without loss of generality, each source xor rotator is a three segmented shift register consisting of two lower segments of 8 bits each, plus an upper segment of 16 bits. The next step is to discard bits from source 1 xor rotator 134 by retrieving 4 bits from path LFSR 2 142 and shifting the upper segment into the lower segments by the number defined by the path bits. This randomizes the bit selection in the lower segments. Accelerated emission controller 145 then performs the same step on source 2 xor rotator 135, using an additional 4 path bits.

The lower segments of each source rotator are successively xored. Namely, 16 bits are retrieved from xoring LFSR 2 144 and xored with the two lower segment bits of source 1 xor rotator 134 with the result stored in the same two lower segments. The same operation is then performed on source 2 xor rotator 135 wherein accelerated emission controller 145 retrieves another 16 xoring bits. This xoring step could be performed after the rotation steps soon to be described. But xoring first is preferred because it better disperses the xoring bits.

The lower segment bits of each source rotator, first source 1 and then source 2, are rotated as follows. Accelerated emission controller 145 retrieves 3 path bits from path LFSR 2 142 and right rotates the low lower segment bits by the path bits count. An additional 3 path bits are applied to right rotate the high lower segment bits. Finally, another 4 path bits are used to right rotate the two lower segments, which act together as one register. 10 path bits are used for source 1, and another 10 for source 2. However, the last path bit for source 2 is reused as will be described shortly. The purpose of the bit reuse is for word alignment; namely so exactly 32 path bits are utilized when forming each emission fragment.

Next, the lower segment bits (16 bits) from source 1 xor rotator 134 are stored in the lower segment of accumulator rotator 136 with the lower segment bits from source 2 xor rotator 135 stored in the upper segment of accumulator rotator 136. Accelerated emission controller 145 then takes the last path bit used with source 2, and retrieves 4 more path bits from path LFSR 2 142. Accumulator rotator 136 is then right rotated by the count these 5 path bits. The contents of accumulator rotator 136 are now outputted on emission bus 32 as the emission fragment value. This word orientated emission fragment generation means is a novel improvement.

The details for accelerated mode amorphous stream generation are now described. These are same as for canonic mode as explained above for holdback multiplexer 29A of FIG. 11 except for the following differences. Whenever slot index 1 118 is set, element selector 2 120 is filled with the contents of the ElementSelector register in the multiplexer slot selected by slot index 1 118. Furthermore, the MasterHoldback register is located in the element descriptor selected by element selector 2 120. Another distinction is that there is a fourth initialization step. Namely, as part of each partition carving, multiplexing controller 123 receives a parsed seed on holdback recarver bus 18, which is sent to accelerated mixer 122.

But the biggest difference is that emission fragment 110 is pulsed multiple times with the bits sent on mixer bus 121 to accelerated mixer 122. Without loss of generality, 8 bits are emitted per emission wherein the total remaining 1 112, emission counter 111 and emissions remaining 113 registers are now decremented by 8 (instead of 1) per adjustment.

In addition, computing the shift count regarding the InitialFragmentSize also needs to be adapted. In particular, the shift count is here set to the emission fragment bit size minus the InitialFragmentSize multiplied by 8. Note that the randomizing effect from the InitialFragmentSize is significantly reduced as compared to canonic mode whose elements have 32 states verses the 4 states in accelerated mode. Unfortunately, the potential to increase the fragment size to achieve more states per element is limited. On a 64-bit machine, the emission fragment size could readily be doubled to obtain a 64 bit emission fragment size, and hence 8 states per element (at the 8 bit emission rate). But the practicality of going beyond that depends on how efficient the CPU handles larger word sizes.

Finally, when an element is recarved, there is the question whether its corresponding multiplexer slots should also be recarved. Creating a linked list of multiplexer slots for each element (thus eliminating searching) renders recarving slots practical. However, the preferred embodiment is to retain the slot values wherein the existing CurrentHoldback value is used as usual. The element's new MasterHoldback is only used when refilling CurrentHoldback. This is preferred because i) the benefit from recarving slots is insignificant, ii) the software code is simpler and iii) it eliminates the linking registers in an accelerated mode hardware implementation. (Note that a hardware implementation would be useful in a mixed environment with some computers only have MAE access via software.)

Next described are the details for accelerated mixer 122 as illustrated in FIG. 17. Regarding the fourth initialization step just mentioned, accelerated mixer controller 154 receives the parsed seed on mixer bus 121 and stores it in mixing LFSR 156. Without loss of generality, 4 emissions (each 8 bits long) will be mixed together in a 3 segmented shift register to form a 32 bit word. Successively, accelerated mixer controller 154 receives 4 emissions on mixer bus 121 and store them in mixer rotator 150, storing the first emission in lower low 153, the second emission in lower high 152, and the next two emissions in upper 151.

Accelerated mixer controller 154 then rotates the lower segments by first retrieving 2 mixing bits from mixing LFSR 156, which are used as the count for right rotating the bits in lower low 153. Subsequently, another 2 mixing bits are retrieved with lower high 152 being right rotated. Finally, 3 additional mixing bits are retrieved with lower high 152 and lower low 153 being right rotated together.

Accelerated mixer controller 154 then rotates the upper 151 bits into the lower segments by pulsing the segments 16 times. Subsequently, the lower segments are rotated as previously described, using 7 more mixing bits. The final step is to retrieve 2 additional mixing bits (for a total of 16), which are used as the count for right rotating all three segments. The contents of mixer rotator 150 are then outputted as the next amorphous stream 38 bits. The accelerated mixer is a novel improvement.

The random source for accelerated mixer 122 could be taken from emission generator 30B. Alternatively, a more complicated multiple LFSR scheme could be used. However, the embodiment of mixing LFSR 156 is sufficient as only minimal permutation is needed to thwart correlating element emissions with the amorphous stream.

6. Blazing Mode Keystream Generation

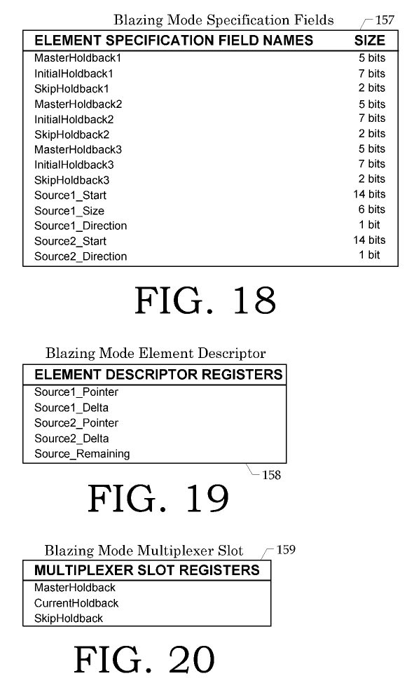

The parsing details for the blazing mode amorphous process are described next. Again, without loss of generality, a 64 KB blazing base key 166 will be partitioned into 512 elements (N=512). The partition index size for the blazing mode machine being presented is 42,976 bits, each element has two independent sources and there are three multiplexer slots per element descriptor for a total of 1536 multiplexer slots (M=1536). The element specifiers are consecutively mapped at the beginning of the partition index, followed by 608 bits used as a recarving seed. Directly following this are four additional sets of 608 bits, each used as a seed for generating path bits. Each element specifier is comprised of 78 bits. Each element specifier is further decomposed into specification fields as defined in the blazing mode specification fields table 157 of FIG. 18.

As each element specifier is evaluated, the values are stored in the corresponding element descriptor and multiplexer slot, whose internal register compositions are respectively defined in the blazing mode element descriptor table 158 of FIG. 19 and in the blazing mode multiplexer slot table 159 of FIG. 20.

The element specification evaluation for blazing mode as exemplified by partition extractor 1 20 is next described. Again, the evaluation is similar to modes previously so only differences will be noted.

The MasterHoldback, CurrentHoldback and SkipHoldback evaluation is the same as canonic mode except there are three sets of specifications fields, each set corresponding to a multiplexer slot that is independently evaluated.

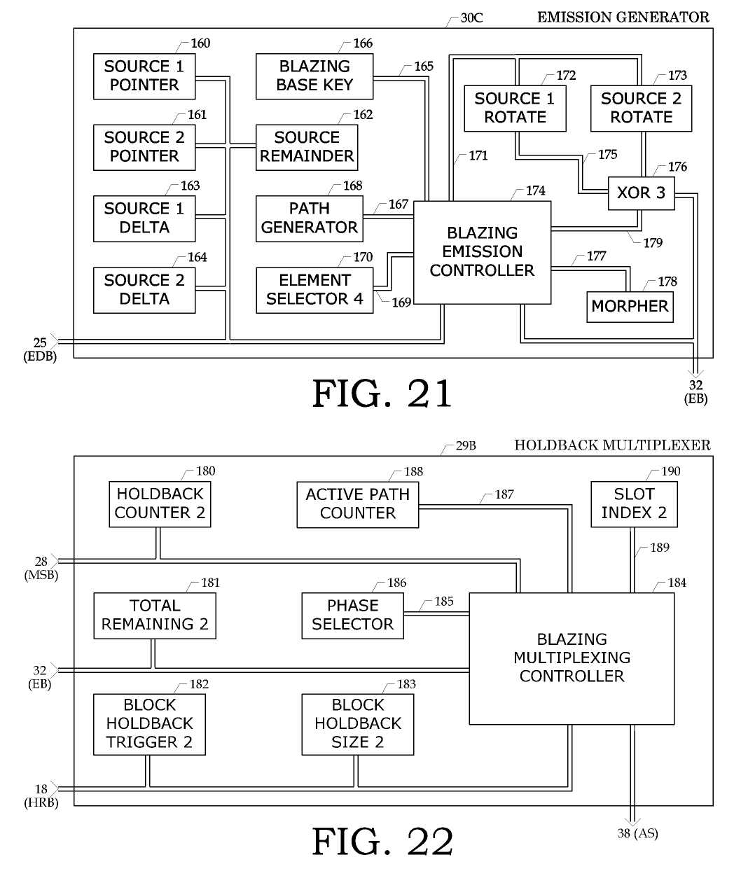

As with accelerated mode, the Source1_Start specification field value defines a 32 bit word aligned address that is a uniform random address, but it is used to address data within blazing base key 166 of FIG. 21. The Source1_Size specification field is also identically evaluated with the result stored in Source_Remaining register. Also, the Source1_Direction specification field is used to fill the Source1_Delta as before. Finally, Source1_Pointer is filled to either the source start or source end, depending on the direction specification.

The Source2 specification fields are then similarly evaluated to fill Source2_Pointer and Source2_Delta wherein the value from Source1_Size is used as the size for the second source as well. Finally, the contents of Source_Remaining is multiplied by 32 (i.e. the number of bits in a word) to form the element emission size value, which is sent to holdback multiplexer 29B for element specifiers that did not originate in the element recarving means. Sharing of the source size and removing the rotation specification is the preferred blazing mode mapping as this simplifies emission generation by eliminating tests for address wrapping.

Note: emission register 1 35 and emission register N 36 are not used for blazing mode as the emission fragment is emitted immediately upon generation. Even emission remaining is not used as the Source_Remaining register handles that functionality.

The details for blazing mode emission generation as illustrated by emission generator 30C of FIG. 21 are described next. Similar to the other modes, element selector 4 170 is used for selecting a specific element descriptor. However, there is no source selector as each source has dedicated registers. Namely, source 1 pointer 160, source 2 pointer 161, source 1 delta 163, source 2 delta 164 and source remainder 162 correspond respectively to the element descriptor registers of Source1_Pointer, Source2_Pointer, Source1_Delta, Source2_Delta and Source_Remaining.

Before emission generation can begin, blazing base key 166 must be filled. The details will be described shortly.

As each partition is carved, emission generator 30C needs to initialize path generator 168. The first step is to receive four parsed seeds and a dispersed seed from element recarver 17, which are routed through emission bus 32 to blazing emission controller 174, which stores them in path generator 168. The second step is xor each of the parsed seeds with the dispersed seed.

The internal structure of path generator 168 is not illustrated, but essentially it consists of four LFSR's, which are seeded as just described. And it contains an active path register that selects one of the four LFSR's as the current source for path bits, which is set to the first LFSR as part of initialization. The active path register is updated whenever path generator 168 receives an update signal from holdback multiplexer 29, wherein the next two path bits are retrieved and used as the next active path value.

Next described is morpher 178, which is used to transform blazing base key 166. The preferred morphing point is after carving each partition index, but a noteworthy alternative is to morph after each block holdback. Morphing after carving makes it possible to advance the keystream pointer without generating all of the intermediary data. Namely, the base key is morphed and only the amorphous stream needed for the next partition index is generated. This facilitates fast forwarding to a specific keystream byte.

Morphing after a block holdback makes “fast forwarding” impossible because morphing is now intertwined with block holdbacks, which occur throughout amorphous stream generation. However, intertwining morphing with block holdbacks results in a more complex morphing transformation, making it harder to correlate the emission fragments to the base key, which is now time dependent.

Morphing is driven by recarving bits retrieved from element recarver 17. Morpher 178 operates by first retrieving several recarving bits to initialize a cycle count register (not illustrated), which defines how many morphing cycles to perform. A morphing cycle consists of retrieving recarving bits (though any suitable random source could be used) used to specify a starting position within blazing base key 166, a transform length and datum value of size transform length. For each cycle, morpher 178 exclusive-ors the blazing base key bits defined by the starting position and transform length with the datum value. Morphing the base key is a novel improvement.

The preceding used random addresses while morphing the base key. An alternative is to use a predefined set of addresses. Here, a morphing cycle begins by determining the number of addresses to morph (this value could be fixed or randomly derived as above). Subsequently, the next address from the set is successively retrieved with the blazing base key value at that location then xored with a datum value derived from the next recarving bits.

The set of addresses should cover the entire base key, and typically be non-overlapping. The simplest set of coverage addresses is that of consecutive addresses. Another useful sequence of coverage addresses is to stripe the base key as follows. Without loss of generality, the starting address is the first base key location which is emitted first, followed by the 1+n location, then the 1+2n location and so on until the address would exceed the base key. Subsequently, the second location is emitted followed by the 2+n location, and then 2+2n, 2+3n and so on, terminating as before. The pattern repeats until all addresses are emitted exactly once. These addressees effectively stripe the base key.

Emission fragment generation is described next, which begins with element selector 4 170 being set to a value. Subsequently, blazing emission controller 174 loads source 1 pointer 160, source 2 pointer 161, source 1 delta 163, source 2 delta 164 and source remainder 162 from the selected element descriptor. The word in blazing base key 166 selected by source 1 pointer 160 is then stored in source 1 rotate 172. Similarly, source 2 rotate 173 is filled based on source 2 pointer 161. Next, 5 bits are retrieved from path generator 168, which define a count that is used to rotate the bits in source 1 rotate 172. Similarly, another 5 path bits are applied to source 2 rotate 173.

The contents of source 1 rotate 172 and source 2 rotate 173 are then xor-ed together by xor 3 176. If source 1 pointer 160 and source 2 pointer 161 both contain the same address, blazing emission controller 174 signals element recarver 17 to send it a word of the next recarving bits, which are sent to xor 3 176 to further xor the contents. Subsequently, the value from xor 3 176 is outputted on emission bus 32 as the emission fragment. Applying xoring bits only for source address collisions is a novel improvement.

Detecting if both sources have the same address is important because a value xored with itself evaluates to 0. Thus, if the rotates are the same, the emission fragment would be 0. Without the additional xoring for source address collisions, the amorphous stream would contain an excess of 0 values, which could be exploited by a cryptographic attack.

The value of source 1 delta 163 is then added to source 1 pointer 160, source 2 delta 164 is added to source 2 pointer 161, and source remainder 162 is decremented. If source remainder 162 is non-zero, the contents of source 1 pointer 160, source 2 pointer 161 and source remainder 162 are stored in the corresponding registers of the selected element descriptor. Otherwise, the contents of element selector 4 170 are sent to element recarver 17, signaling it to refill the specified element descriptor and multiplexing slots.

The details for blazing mode amorphous stream generation as implemented by holdback multiplexer 29B of FIG. 22 are described next. The three initialization steps as described for the canonic mode holdback multiplexer are identically performed here as well. This initializes total remaining 2 181, block holdback trigger 2 182, block holdback size 2 183, and slot index 2 190.

But there are two new registers that also need initialization. Phase selector 186 has a range of 1 to 3, which selects one of the three multiplexer slots associated to a given element descriptor, and is initially set to the first slot. Active path counter 188 is initially reset. This counter resets itself after counting up to a predefined threshold whereupon path generator 168 is signaled to update its active path register. For this example, the threshold is 3, which happens to coincide with the phase count.

Once initialized, the amorphous stream is generated by repetitively cycling through the multiplexing slots. First, blazing multiplexing controller 184 uses slot index 2 190 and phase selector 186 to select a multiplexer slot and read the CurrentHoldback register, storing its value in holdback counter 2 180, which is then decremented. Multiple holdback sets provide for a richer element fragment mixing, and also naturally lends itself to code unwrapping in conjunction with the phase size. Phased multiplexing via multiple sets of holdback slots per element is a novel improvement.

If holdback counter 2 180 is decremented to zero, a holdback occurs wherein blazing multiplexing controller 184 reads the MasterHoldback register from the selected multiplexer slot, and stores the value in the corresponding CurrentHoldback register. Also, SkipHoldback register is read with its value multiplied by 3 (i.e. the number of phases) with the product added to slot index 2 190, subjected to wrapping. Finally, block holdback trigger 2 182 is decremented wherein a block holdback is performed if the trigger goes to zero.

A block holdback consists of multiplying block holdback size 2 183 by the number of phases with the product added to slot index 2 190. Also, a refill block holdback request is sent to element recarver 17 with the same functionality as for canonic mode, which refills block holdback trigger 2 182 and block holdback size 2 183. However, since block holdbacks are triggered off emission holdbacks, the trigger calculation is slightly different. Namely for this example, a base trigger of 10 (instead of 400) is used yielding a holdback trigger range of 10 to 137. While not necessary, triggering on emission holdbacks (verses per emit) is preferred as it moves the trigger test out of the critical loop, thus providing faster execution. As previously mentioned, block holdbacks are a novel improvement wherein triggering off emission holdbacks is a new embodiment for blazing mode

If holdback counter 2 180 is non-zero after being decremented, its contents are stored backed to the CurrentHoldback register, phase selector 186 is advanced, and an emission occurs. Emission processing begins with blazing multiplexing controller 184 deriving the element selector that corresponds to slot index 2 190. The element selector is sent to emission generator 30C, which sends an emission fragment on emission bus 32 directly to blazing multiplexing controller 184 that is outputted as the next bits of the amorphous stream 38. Subsequently, active path counter 188 is pulsed with the active path conditionally updated as described above. Slot index 2 190 is then advanced to point to the next element. Finally, the word size (32 bits) is subtracted from total remaining 2 181, and partition index manager 15 is signaled to carve a new partition when the total goes to zero.

The final detail regarding blazing mode is how blazing base key 166 is filled. While any random number source could be used, the preferred source is the initial keystream from either a canonic or accelerated mode amorphous process. It is further preferred that the initial partition index for the blazing mode machine be filled using the following bits of the same source, subject to partition index manager transformation. This scheme still utilizes message key exploder 13, but it only indirectly fills partition index register 60.

Source address collisions (with same rotate values) occur 1 in 2¹⁹ emissions, which is once for every 2 megabytes emitted. Typically, 2 MB of keystream is more than an attacker can obtain, but not in some environments and hence it could be exploited if the extra xoring stage was not added.

However, different source addresses can also contain the same value. The “birthday surprise” statistic for a random 64 KB base key to contain two identical 32 bit values is approximately 1 in 33. The statistic is higher still for values that are nearly identical, i.e. values that vary in only a few bits. Identical values could reasonably be detected via a sorted list or a hash table. But finding nearly identical values is significantly more computationally intensive

Source value collisions result in emissions with few or no bits set to 1. Fortunately, the statistic is estimated to be roughly 1 in 2³⁰ emissions. Empirical testing has confirmed this magnitude. Since the base key would be entirely morphed many times before such an event, source value collisions can safely be ignored.

Blazing mode was exemplified using a 32 bit fragment size. The parameterization will be explained as it is critical. The number of different ways to form a fragment is approximately 2³⁷. Namely, a 64 KB base key has 2¹⁴ 32 bit words, which yields 14 bits for the first source and 13 for the second source (accounting for duplicate combinations). As 5 bits are used to rotate each source, the total is 14+13+5+5=37. Since a fragment has 2³² possible values, each fragment value could come from one of 2⁵ evaluations. Thus, on average, a given fragment value could result from 1 of 32 possible source/rotate evaluations. The point is that a fragment value does not uniquely identify its evaluation means. And just as important, each fragment value will (almost) always be generated by some evaluation.

Now consider a 64 bit fragment size. Using the same base key size, this results is 13+12+6+6=37. The number of possible evaluations remains at 2³⁷, but the number of possible fragment values has grown to 2⁶⁴. Hence, not all fragment values can be generated, which obviously is bad. Using a larger base size and more sources would help. But a 256 KB base key with three sources only yields 2⁵⁷ evaluations. It would take four sources (which yields 2⁷⁴) to finally break the 64 threshold. But using additional sources is not computationally attractive as this four sources 64 bit example would be about 12% slower than the 32 bit embodiment.

Another approach is triple rotates per source: rotate upper bits, lower bits, and then all bits. This consumes 5+5+6=16 bits per source, which totals to 57 for a 64 KB base key. Injecting 8 substitution bits increase the total to 65, which is useable as each fragment value could result from 1 of 2 possible evaluations. However, 16 CPU instructions are needed for the 32 bit evaluation while 28 instructions are necessary for this 64 bit version. Hence, instead of doubling the performance as would be the hope with moving to 64 bits, only about a 12% gain is achieved. But this doesn't account for generating the xoring bits and additional path bits. So this approach will typically be slower as well.

The preferred 64 bit embodiment consists of two sources, a single rotate per source, and using 32 xoring bits per fragment wherein 16 xoring bits are applied to the lower source bits (per source) before rotating the source bits. This utilizes 69 entropy bits per fragment and only needs 4 additional CPU instructions, which would provide about a 75% performance gain, ignoring entropy bits generation. For a 32 bit emission fragment, 10 entropy bits yields 32 fragment bits. But using the preferred 64 bit embodiment, it takes 44 bits to yield 64. The proportion of entropy bits has more than doubled. Fortunately, bit generation should be twice as fast when using 64 bit registers, so the net effect isn't huge. Thus, a solid performance gain of around 50% is possible without resorting to using fewer xoring bits or a faster random bit generator (like the trinomial method for LFSRs).

Finally, since so many xoring bits are needed, the preferred 64 bit embodiment also employs an xoring generator, independent but identical in structure to path generator 168. The multiplexer has 5 phases. As 12 path bits per fragment are needed for rotates, the number of excess path bits is (64−12*5)=4 bits. As before, two of these bits are used to select the next active path, with the remaining 2 bits similarly used to select the next active xoring LFSR in the xoring generator.

7. Morphing Amorphous Encryption Keystream Generation

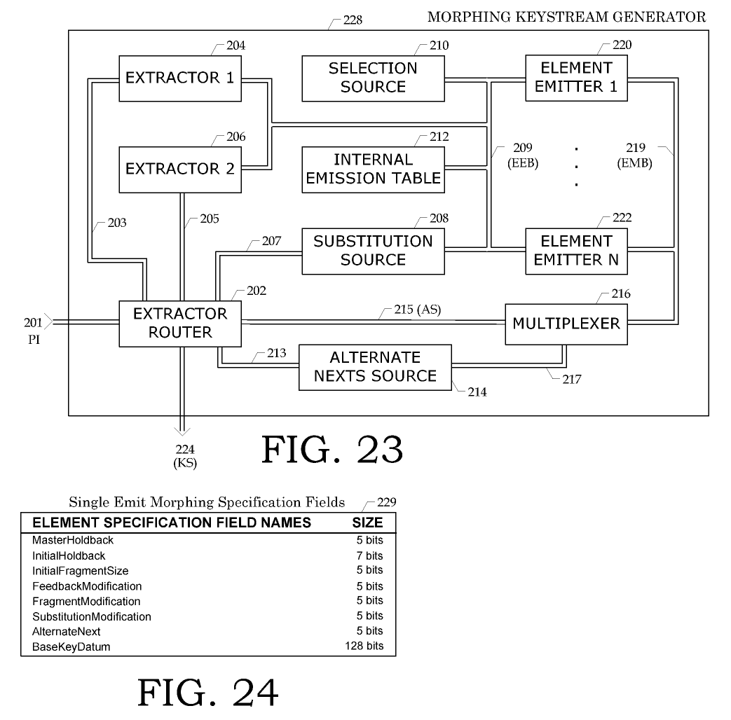

The morphing base key version of the MAE keystream generator is described next, which has two distinct preferred embodiments. These embodiments share a common structure that is substantially similar to the monobase version of FIG. 1. However, a simplified and restructured diagram will be used better illustrate this version via the morphing keystream generator 228 of FIG. 23.

The morphing keystream generator is based on a secret base key that is morphed (i.e. transformed) during amorphous keystream generation. The blazing mode amorphous process also uses this technique. But here, the focus is on systems whose base key primarily consists of the state of a collection of random sources. These random sources could be any suitable random number generator. However, the embodiments to be presented will utilize LFSR's, which are especially apt for a morphing keystream generator.

The basic operation of morphing keystream generator 228 of FIG. 23 is as follows. Operation begins by sending partition index 201 into extractor router 202, which decomposes it into a sequence of N element specifiers that are sent to extractor 1 204 and extractor 2 206. Multiple extractors are illustrated to denote that the carving process is parallelizable. The extractors evaluate the specifiers and subsequently fill element emitter 1 220 through emitter N 222, communicating via element emitter bus 209. Certain data within the element emitters represents the base key. Partition index 201 for the first embodiment consists of a partition index from a message key exploder as illustrated in FIG. 2. Note that the base key is specified by the partition index wherein partition carving now has a more generalized sense. A message key exploder could provide partition index 201 for the second embodiment as well. However, around 32 KB is needed. In addition, this embodiment is intended for software implementation. Thus, the preferred partition index source is from a canonic mode keystream generator.

After the element emitters are filled, extractor router 202 decomposes the remaining partition index 201 bits into three seed values, which are respectively sent to selection source 210, substitution source 208, and to the block holdback random source contained within multiplexer 216. In addition, extractor router 202 sends a seed value to alternate nexts source 214, wherein this seed value is calculated in the same manner as the dispersed seed of FIG. 5. Its calculation also serves the same purpose; namely, to reduces partition index clustering.

A priming step is then performed where after amorphous keystream generation begins with multiplexer 216 receiving data from the element emitters beginning with the first emitter. Substitution source 208, selection source 210 and internal emission table 212 are used by the element emitters when forming emission data, which will be described shortly. Multiplexer 216 concatenates the emission data received from the emitter multiplexer bus 219 to form amorphous stream 215 that is sent to extractor router 202, which in part defines a next partition index with the remainder outputted as the keystream 224. Multiplexer 216 also uses alternate nexts source 214 as part of the multiplexing process. In addition, element recarving could be utilized, though for simplicity such functionality is not detailed. In brief, the preceding is a terse description of an expanding amorphous process.

The main difference here is the use of element emitters. Logically, each element emitter is a combination of an element descriptor 23, multiplexer slot 26, emission register 35 and emission generator 30 of FIG. 1. This combined format was chosen to better represent the embedded generation nature of elements in a morphing keystream generator.

7A. Single Emit Morphing Amorphous Encryption

The parsing details for the first embodiment of the morphing keystream generator are described next. This embodiment will be referred to as the single emit embodiment as element emission bits will be multiplexed one bit at a time. This embodiment is geared towards a hardware implementation optimized for minimal chip size. Without loss of generality, a 86,304 bit partition index will be carved into 512 elements (N=512). The element specifiers are consecutively mapped at the beginning of the partition index, followed by 608 bits used as a selection seed, plus another 608 bits used as a substitution seed and followed by another 608 bits used as a block holdback seed. Each element specifier is comprised of 165 bits, which is further decomposed into specification fields as defined in the single emit morphing specification fields table 229 of FIG. 24. (For a production system, the SkipHoldback specification field would typically be defined and used as previously described in the monobase version. But this field was not shown here for sake of simplicity.)

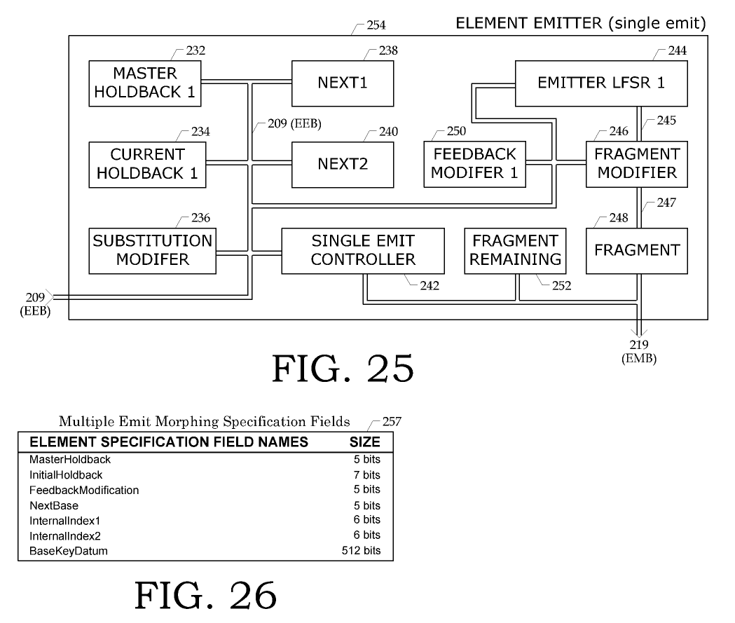

As each element specifier is evaluated, the values are stored in the corresponding element emitter. FIG. 25 illustrates an element emitter 254 with its internal registers for the single emit embodiment. The specification evaluation as exemplified by extractor 1 204 is as follows. The MasterHoldback, InitialHoldback and InitialFragmentSize specification fields are evaluated the same as for canonic mode, the values being stored in master holdback 1 232, current holdback 1 234 and fragment remaining 248. The FeedbackModification, FragmentModification and SubstitutionModification specification field values, each with range of 0 to 31, are stored in feedback modifier 1 250, fragment modifier 246 and substitution modifier 236, respectively. Next1 238 is set to point to the following element emitter wherein the value for the last element emitter is wrapped so that it points to the first element emitter. The AlternateNext specification field (5 bits) value, whose range is 0 to 31, is modified to point to one of the following 1^{st} through 32^{nd} element emitters, based on the specification value and subject to wrapping, the value being stored in Next2 240. Finally, the BaseKeyDatum specification field value is copied directly into the Emitter LFSR 1 244. The other registers will be described later on.

The priming step consists of filling internal emission table 212 with data from substitution source 208 and filling fragment 248, which includes the initialization of fragment remaining 252. Element emitter 1 220 is primed first, with the other emitters primed in sequence. Internal emission table 212 is comprised of an array of registers. Without loss of generality, this array contains 64 registers, each register 32 bits wide. Priming sequentially initializes these registers, beginning with the first.

The generation of an emission fragment is as follows. Single emit controller 242 retrieves the lower bits of emitter LFSR 1 244 and sends them to fragment modifier 246, which rotates the bits by the count specified by FragmentModification, with the modified bits stored in fragment 248. Single emit controller 242 then fetches the next internal substitution emission (to be described shortly). The substitution emission is first sent to substitution modifier 236, which rotates the bits by the count specified by SubstitutionModification, with the modified bits then xored with the lower bits just retrieved from emitter LFSR 1 244. The xored bits are sent to feedback modifier 1 250, which rotates the bits by the count specified by FeedbackModification, with the modified bits stored into the lower bits of emitter LFSR 1 244. Emitter LFSR 1 244 is then advanced by the register size of fragment 248.

The process for fetching the next internal substitution emission begins with single emit controller 242 reading the next bit from selection source 210. If the selection value is zero, substitution source 208 is read directly to provide the internal emission. Otherwise, the lower bits of the effective element index are used to select a register within internal emissions table 212. (E.g. if element number 379 is being processed, the element index, in binary, is 101111011. The lower 6 bits are 111011 so that the 60^{th} register in the array is selected.) The contents of selected internal emission table 212 register is read provide the internal emission, with that same register then refilled with the value then read from substitution source 208.

The final detail of emission fragment generation consists of initializing fragment remaining 252 to the bit count in fragment 248. However, when this occurs during priming, the InitialFragmentSize value that was stored in fragment remaining 252 also has to be processed. Namely, the lower bits in fragment 248 are discarded via a shift operation with the fragment count adjusted accordingly in the same manner described previously for canonic mode.

Fragment 248 is filled with the unaltered lower bits from emitter LFSR 1 244 (albeit subject to a rotation). Alternatively, the xored bits could be used as the emission fragment. But the preferred embodiment is to apply the internal substitution emission after the extracting the lower bits so that the substitution bits are outputted more indirectly via a pass through the LFSR.

Of particular note is that the emitter LFSR's are not free running. Their feedback bits are constantly being modified via an internal emission, which significantly breaks the feedback loop. This greatly weakens the parity relations by limiting the immediate parity relations to bit sequences of the length of the LFSR. The remaining parity relations are weakened from the injection of internal emission bits, whose effect increases as generation proceeds. This should result in element emissions that are much more resilient to fast correlation attacks (albeit these are not even directly output but rather multiplexed).

The interaction between multiplexer 216 and the element emitters is described next. When multiplexer 216 requests of a bit from the selected element emitter, the corresponding single emit controller 242 begins by decrementing current holdback 1 234. If the result is zero, a holdback occurs wherein the contents of master holdback 1 232 are copied into current holdback 1 234. In addition, the next bit is read from alternate nexts source 214, whose value is used to select either next1 238 or next2 240. The selected next value is send to multiplexer 216, which is used to specify the next element emitter. (Block holdbacks are also processed in the manner described in the monobase version. Therefore, the details will not be repeated.)

If the decremented current holdback 1 234 result is non-zero, an emission occurs. Here, a bit from fragment 248 is shifted out and send to multiplexer 216 for use as the next amorphous stream bit. Fragment remaining 252 is then decremented. If the result is non-zero, the emission is complete. Otherwise, fragment 248 and fragment remaining 252 are refilled by the process described above.

Since small chip size is important for this embodiment, a 10,788 byte register will not be used to store the next partition index. Instead, incremental partition carving is employed. Incremental carving is based on a trigger event. When triggered, extractor router 202 captures the next 165 bits from the amorphous stream, routing and storing them in a delta partition index register. Upon filling, these bits are sent as an element specifier to the appropriate extractor whereby an element emitter is refilled. This process repeats, sequentially refilling all of the element emitters. Subsequently, three additional trigger events are processed, each capturing 608 bits for use as a seed value, which are used to refill each of the random sources. In additional, all of the next partition index bits are sent to the dispersed seed calculator, the result being sent to refill alternate nexts source 214, which completes a partition index recarving cycle.

The delta partition index register is 76 bytes in size (i.e. big enough to hold the largest item, namely the 608 bit seed value). The delta register is considerably smaller than 10,788 bytes. Thus, incremental partition carving reduces the chip size significantly.

Holdbacks are the preferred means to derive the trigger event as these lend to good software performance. Either standard or block holdbacks can be used. To wit, after a fixed number of holdbacks, the trigger event is fired. By setting the countdown value appropriately, the entire partition will be recarved after generating a specified number (on average) of keystream bits, say 70 KB. In brief, the countdown value is set based on the average generation rate per holdback.

7B. Multiple Emit Morphing Amorphous Encryption

The second preferred embodiment for the morphing base key version is described next; namely, the multiple emit version wherein element emission bits are multiplexed several bits at a time. The multiple emit embodiment is geared to software implementations, and is optimized for speed. The parsing details for this embodiment are henceforth described. As with single emit, 512 element specifiers are consecutively mapped followed by the same three seeds. However, each element specifier here has 546 bits resulting in a 281,376 bit partition index with the element specifier decomposition defined in the multiple emit morphing specification fields table 257 of FIG. 26.

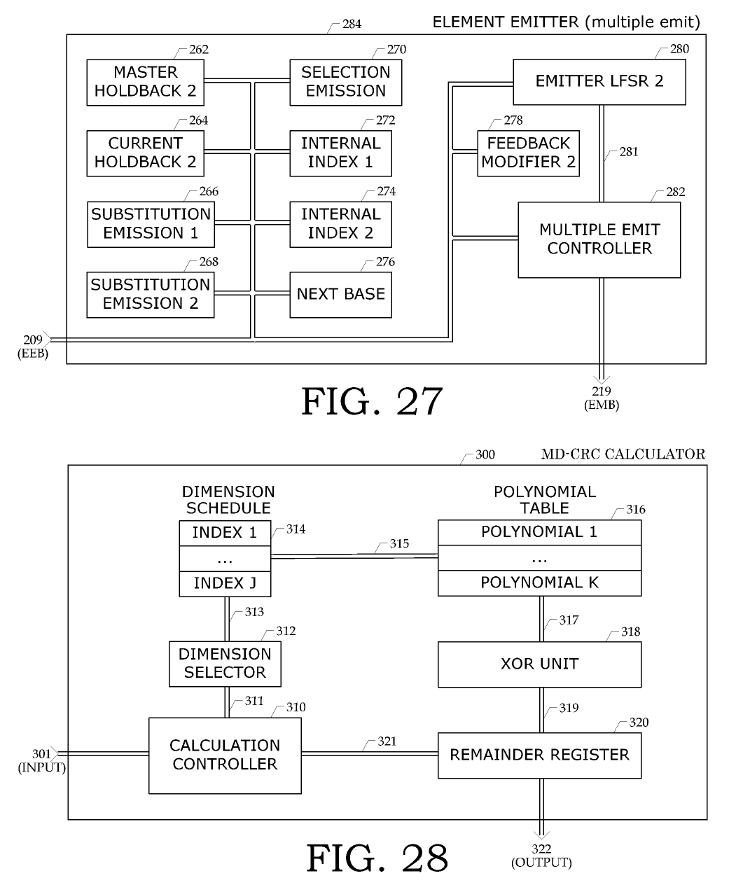

Again, each element specifier is evaluated with the values are stored in the corresponding element emitter, whose internal registers are illustrated in element emitter 284 of FIG. 27. Evaluations for the MasterHoldback, InitialHoldback and FeedbackModification specification fields are identical to the single emit evaluations, with the values stored in master holdback 2 262, current holdback 2 264 and feedback modifier 2 278. The NextBase specification field (5 bits) value, whose range is 0 to 31, is stored in next base 276. Similarly, the InternalIndex1 and InternalIndex2 specification fields (each with range 0 to 63) are stored in internal index 1 272 and internal index 2 274, respectively. Finally, the BaseKeyDatum specification field value is directly copied into Emitter LFSR 2 280.

As with single emit, internal emission table 212 consists of 64 32-bit registers and is filled as before during priming. The priming step further consists of initializing substitution emission 1 266, substitution emission 2 268 and selection emission 270, with each element emitter primed in sequence. Substitution source 208 provides the data for substitution emission 1 266, substitution emission 2 268 while selection source 210 provides the data for selection emission 270. In addition, priming fills the substitution selection register, located in multiplexer 216, with the next bits from selection source 210.

An emission fragment is fully emitted immediately after being generated. Hence, the fragment and count registers are not use. Fragment generation is similar to single emit: the exceptions being substitution and fragment modification are not used, plus the retrieval of the substitution bits is different, which is described next.

Substitution retrieval begins with multiple emit controller 282 reading the next two bits from the substitution selection register. If the selection value is zero, substitution emission 1 266 is read to provide the substitution bits, with substitution emission 1 266 subsequently refilled with the next bits from substitution source 208. Similarly, if the selection value is one, substitution emission 2 268 is utilized and refilled. But if the selection value is two, the value of internal index 1 272 is used to select a register within internal emissions table 212. The contents of selected internal emission register is read provide the substitution bits, with that same register then refilled via substitution source 208. Finally, when the selection value is three, internal index 2 274 is similarly utilized.

Without loss of generality, the substitution selection register is 32 bits in size, which provides 16 selection values before it is empty. Upon being emptied, substitution selection register is refilled with the value of selection emission 270 corresponding to the current element emitter, with the same selection emission 270 then refilled via selection source 210.

The operation of multiplexer 216 is the same as before with two exceptions. First, the whole fragment is emitted when an emission occurs. The second difference regards the calculation of the next element when a holdback occurs. Here, multiple emit controller 282 reads the next 5 bits from alternate nexts source 214 with the value xored with the contents of next base 276. The xor result is used as a delta that is added to the effective current element index to provide the next element index, which is sent to multiplexer 216.

Regarding next partition carving, here again, the register size to hold an entire next partition index is fairly large, around 34 KB. This is not prohibitive for software but it would degrade performance. But recarving the base key bits is less important here (because of the stronger substitution means) than for the single emit embodiment. Hence, the preferred partition recarving method is to use a partial partition index that excludes the BaseKeyDatum bits from each of the 512 element specifiers. This results for the given parameters in a register size of 2,404 bytes.

In brief, extractor router 202 fills the partial partition index with the initial amorphous stream, and routes the rest as keystream up to some fixed amount, say 80 KB. Whereupon the partial partition index is processed as before except none of the emitter LFSR 2 280 are modified.

A good partition carving variant is to slightly alter the partition index mapping. Namely, the BaseKeyDatum specification fields are moved to a contiguous block at the end of the initial partition index. This makes the structure of the initial partition index closer to the partial partition index, which results in more uniform processing.

7C. Benefits and Generalizations

Four novel improvements have been introduced regarding the morphing base key version, the first being internal emissions. Internal emissions tap into the inherent complexity of the emission fragment generation and holdback multiplexing processes. These two processes are not independent but rather fragment generation and multiplexing operate together yielding a single process with a semi-permutation effect.

The chief benefit of internal emissions is they provide fairly cryptographically secure random number streams. The end result is similar to using an internal independent amorphous process, but without the complexity of another amorphous process along with reduced software performance. Internal emissions do interject a coupling factor to the amorphous stream generation, so care is needed to ensure this doesn't open a security hole.

But internal emissions do have salutary property due exactly to coupling. Namely, it thwarts divide-and-conquer attacks. There is a “natural internal emission” when retrieving from random sources while multiplexing. But the caching level added by internal emissions significantly deepens the permutation effect. In brief, using internal emissions results in an encryption system whose security rating is close to that of the size of the partition index

Two forms of internal emissions have been described though other variations exist. The key concept is to store values from an internal random source and then later retrieve them. The retrieval entails a selection based on a selection value. The selection value can be formed from a random source as exemplified with selection source 210. Or alternatively, the selection value can be derived from the system state, typically the current element's state. For example, the lower bit in source 1 register 88 (of FIG. 10) could be defined as the selection value for canonic mode embodiment. While a derived selection value is simpler, it does introduce a dependency so that using a random source is preferred. A minor variation that eliminates this dependency is to calculate a specification field value when carving the element. This value would be constant, but it is independent of the element's state.

The simplest selection value evaluator is to output a constant. In other words, there is no choice. For example, consider when each element has one emission register for storing a random source value. When an internal emission value is needed, the value in the current element's emission register is used, which is then refilled via the internal random source. This mode is very simple. But it is still valuable as it does introduce complexity on random source usage.

The storage of internal random source values can be independent as illustrated with internal emission table 212 or element dependent as illustrated via substitution emission 1 266. Another example of dependent storage would be to include emission registers on multiplexer slots. Dependent storage can be one or more levels deep (i.e. the number of storage registers), and independent storage can also be one or more levels deep (i.e. the number of nested emission tables). Priming can be based a random source. Or alternatively, priming data can be taken directly from the partition index. Note that the canonic mode caveat regarding non-feedback systems also applies here. Namely, the random source words may need to be permuted during priming to thwart correlation attacks.

Besides the selection value, an index is needed to select which internal emission register to use. For the single emit embodiment, the index was derived from the effective element index (i.e. using the lower bits). For the multiple emit embodiment, the selection value was used to select from one of two specification field values with the selected value used as the index. A simple variation of this is to have a single specification field value that is used as the index (with no selection needed). However, the most general index evaluator to form the index from a random source. Other index evaluators exist, such as deriving from state data, but these are of lesser interest. Note that an index is not needed when only one internal emission register exists within the scope of the selection, for example when using element dependent storage with a single register per element.

For the single emit embodiment, independent storage was preferred to minimize memory requirements. But for the multiple emit embodiment, a stronger substitution random source was desired because the element permutation effect was less without an InitialFragmentSize. Hence, both dependent and independent storage was used. Of course, additional internal emissions could be simultaneously employed, such as an alternate nexts source based on independent storage.

Internal emissions can also be used with monobase amorphous encryption. The path and substitution sources for canonic and accelerated mode are ready candidates for internal emissions by either dependent or independent storage, or both. These would be good level 2 extensions as the additional processing power needed for element emission generation would be covered by a dual core CPU.

Another level 2 extension is internal emissions for the recarving source, which also supplies block holdbacks. The simplest means to emit recarving bits is to use independent storage wherein the internal emission table registers have the same size as an element specifier. Straight element dependent storage is not as attractive because the specifier size is fairly large.

But a caching system to provide non-aligned retrieval is possible based on dependent storage registers of say 16 bits each. Here, a cache register sized about twice the size of an element specifier is employed. When the number of available cache register bits approaches that of the specifier size, a filling mode begins wherein the corresponding dependent value is retrieved after each holdback and stored in the cache register until the cache is filled. When an element specifier is requested, any bits beyond those in the cache register would be retrieved directly from the random source. But this isn't a problem as the refill parameters and cache size can be suitable chosen so that direct source retrieval is statistically rare.

This non-aligned retrieval technique is more complicated than prior examples that were based on an event where it was practical to uniformly extract the exact number of bits needed. But the non-aligned retrieval technique is a general solution, which could be used for block hold back bits, etc. Furthermore, cache register filling could be based on independent storage as well, which would further reduce register memory.

Another interesting use for internal emissions is for the element sources in a canonic mode system. In fact, this eliminates the need for the monobase key while still retaining the core element emission generator structure: thus yielding a “canonic” morphing base key amorphous encryption system. This usage does not disclose any additional novel ideas. But because it is an important category, an embodiment based on independent storage will be sketched out. It will use 4 KB for internal emission tables instead of a 64 KB base key; thus saving 60 KB of memory.

In brief, two internal emission tables are used, one each for source 1 and source 2. Each emission table is an array of 512 registers with each register being 32 bits wide. For each source in each element descriptor, there are two internal index registers, each 9 bits wide. When a source value is need to form an element emission fragment, a bit is retrieved from a selection source, which selects one of the internal index registers for the corresponding element. The value of the selected internal index is used to select a register in the corresponding internal emission table. The value of this selected register is used as the source value with the selected register in internal emission table updated with the next value from a source (random) source.

In addition, each source for each element has two rotate values. After a source value is fetched, a rotate selection bit is retrieved, which selects one of the rotate values whereupon the selected rotate value is applied to the source value, thus yielding the final value that is used as a source.

Using internal emissions for element sources does require the generation of considerably more random bits, thus rendering it a level 2 technique. Yet, the element specifier mapping is fairly similar. 29 bits per source verses 40 bits are used (the direction specification field is retained though the size and truncate specifications goes away). And adding another internal index register per source would result in 38 bits, which nearly equals the prior mapping. It would be prudent to use multiple random number generators to supply the internal emission table values; and possibly use dependent storage (at the cost of another 4 KB of memory) as well. In conclusion, using internal emission element sources is a good approach for amorphous encryption.

The second novel improvement introduced in connection with the morphing base key version is alternate nexts. In previous embodiments (except for accelerated mode), elements were sequentially chained together. Alternate nexts provide a means to go beyond a simple chain. Two forms of alternate nexts have been presented.

The first form used a random source to select a next pointer. Only two next pointers per element were defined, but defining additional next pointers is possible via additional specification fields. Also, the first next pointer was defined to point to the element's successor, but it could have been derived from an element specification field as well. The generalized structure consists of a pool of next pointers and a selection means to choose from the pool.

The pool can contain two types of next pointers: i) fixed increments and ii) specification field derived. The element's immediate successor is an example of a fixed increment next pointer. But the pool could contain other fixed increment next pointers, say the 3^{rd}, 5^{th} and 9^{th} element successors. This portion of the pool could even be based on the element index, say with even elements having 1^{st}, 3^{rd}, and 7^{th} and with odd elements having 2^{nd}, 5^{th} and 9^{th} element successors.

The specification field derived type of next pointers has two variations. The first variation is the delta value as described earlier wherein the specification field value acts as an element index delta. In general, a base value is used wherein the delta value=base value+specification field value (a base value of 0 is reduces this to the prior case). Also note that if all elements are spanned by the specification field, the specification value could be used directed as the next pointer.

The second variation uses the specification field to select from a set of fixed increment next pointers. For example, a 2 bit specification field could select from the 3^{rd}, 5^{th}, 7^{th} and 9^{th} element successors. This variation has the advantage of expanding the effective next element range for a given number of specification field bits.

As a practical example, consider a pool with two fixed increments next pointers, the 1^{st} and 2^{nd} successors, plus two selection next pointers as derived from the prior example. Here, only 4 specification field bits are needed per element resulting in pools containing 4 next pointers (ranging from 1 to 9) wherein 2 bits are needed to select from a pool. The next result is very rich alternate nexts that significantly enhance the multiplexing process.

When defining of a pool, the preferred way is to include the 1^{st} successor so that all element advancement paths are possible. Also note that while including predecessor type alternate nexts is possible, they should be avoided to prevent introducing element advancement loops. Finally, pools could be defined for use with a collection of elements. This is practical for hardware, but much less desirable for software as the pool must contain deltas and thus incur the penalty of computing the next pointer at each use in the critical multiplexing loop.

The preferred selection means to choose a next pointer from a pool is simply to evaluate a selection value that is used as an index into the pool. The selection evaluator for the single emit embodiment formed a value using the next bits from a random source. Another selection evaluator is to use element state bits as described in conjunction with deriving the selection value for an internal emission. Another selection evaluator is to use a random source (or a portion of the partition index) to fill a small buffer, say 128 bits wide, when carving each partition. Here, the selection evaluator successively emits bits in a sequential and cyclic manner. With a 2 bit selection value, this would repeat after 64 values. While less than ideal, this does eliminate the computational costs of a random source; and considering the next element variance introduced by block holdbacks and the alternate nexts themselves, the pattern of selection values would infrequently be applied to the same sequence of elements. However, combining this approach with the element state bits means is preferred. E.g., derive two bits from the element state and xor them with the next two bits from the buffer to form the selection value. One final selection evaluator is simply to emit a constant as the selection value. This trivial case is useful when only one next pointer is in a pool, which is possible if say elements with odd indexes are defined to only use the 1^{st} successor.

As described in the multiple emit embodiment, the second form of alternate nexts evaluates a delta value by xoring a random source value with a base value defined from an element specification field, with the element advanced to the element index defined by adding the delta value to the current element index using modular arithmetic. The delta value is discarded after being used. A simple variation is not to discard the delta value but rather to store it as the new base value. This has the advantage of adding random source entropy while preserving the entropy from the specification field. Another variant for next element evaluation is to xor the random source value and base value together with the result defined as the next element index. This has the advantage of eliminating an addition operation, but it works best only when the random source value's range spans all elements. Again, this variant supports the simple variation of storing the result as the new base value, though possibly subject to truncation if the register is smaller.

One additional variation of the second form is to eliminate the base value wherein the delta value is exclusively defined from the random source, though this has the disadvantage of not introducing and not preserving partition index entropy. But again, if the random source value's range is large enough, element index values can be directly formed instead using intermediate delta values.

The second form is more powerful than the first. But it is les attractive for software implementations as the next element pointer needs to be calculated in the critical multiplexing loop, and more random source bits are needed. Alternate nexts were defined in conjunction with standard holdbacks. However (though possibly as a level 2 technique) alternate nexts can be utilized after element emissions as well, or in combination. Specifically, alternate nexts processing can occur after each standard holdback, after each element emission, or after each standard holdback and element emission, with the default advancement used when not using alternate nexts.

In conclusion, alternate nexts perform well and are fairly compact. And even a single next pointer per element substantially increases the permutation effect when used in conjunction with element emissions. This form of alternate nexts is an attractive substitute to the accelerated mode scheme of employing four times as many multiplexer slots as elements. Alternate nexts complement the randomization provided by InitialFragmentSize, and is applicable to monobase key embodiments as well.

The third novel improvement is incremental partition carving. Its chief benefit is the vast size reduction of the partition index register as illustrated with the single emit embodiment. Standard or block holdbacks are preferred means to trigger the capture event. Alternatively, the trigger could fire after a fixed (or random) number of bits are outputted. The preferred capture size is the number of bits needed to carve a single element or item (e.g. a seed). But a larger capture size is possible via a larger delta partition index register so that multiple elements could be carved per event. Alternatively, the capture size could be less than the element so that multiple events are required to fill the delta register before carving an element. Finally, the preferred incremental partition carving order is the same order as initial partition carving (e.g. carve the elements first, etc) so as to reuse ordering mechanism.

Incremental partition carving can also be used with the monobase embodiments. Though, one particularly attractive candidate is the “canonic” morphing base key system as this would further reduce the memory requirements by another 6 KB. The only downside of incremental partition carving is the loss of ability to fast forward through the keystream via not generating the keystream output.

The multiple emit embodiment did introduce a form of incremental partition carving via the concept of a partial partition index. But that simply was to exclude the large base key data from the next partition index, and is not of general interest.

The fourth and final novel improvement of this section regards filling the base key. With the single emit embodiment, the base key is filled with a portion of the partition index at each partition carving. This injects a new base key for each partition. Together with base key morphing during keystream generation, injecting new base keys significantly secures element emission generation.

One additional idea highlighted with morphing base key encryption is that of modifiers. The single emit embodiment used three modifiers for fragment generation (feedback, fragment, and substitution) while the multiple emit embodiment only used one (feedback). In brief, a modifier is transformation that is parameterized via a specification field taken from the partition index. This is nothing new. The Source1_Direction and Source1_Rotation canonic mode specification fields do exactly that when deriving a source value. But the modifier concept was given an explicit name as its usage is almost required for the morphing base key embodiments because monobase specification fields such as start, size and direction don't apply.

A modifier transformation could be complex, though the spirit of amorphous encryption dictates simplicity. For good software performance, logical operations are the preferred modifiers, arithmetic operations are of lesser interest. The modifiers thus far used bit rotation. Logical NOT, based on a single bit specification field, is another good modifier. Multi-level rotates as well as combinations of NOT operations are also useful modifiers.

In addition to the morphing base key embodiments, modifiers could be used in the monobase embodiments as well. Substitution, path and fragment modifiers are obvious choices, though these principally belong with level 2 techniques. Since modifiers are based on specification fields, their usage must be balanced against excessive partition index size.

One generalization for modifiers is to define a base value via a specification field. A random source is then used to provide a random value that is added to the base value, the result being used as the transformation parameter.

8. Multi-Dimensional Cyclic Redundancy Code Evaluation

The MD-CRC calculator 300 of FIG. 28 will be described now. Md-crc evaluation begins with calculation controller 310 initializing two registers. First, dimension selector 312 is reset so that it addresses the first register of the array of registers that comprise dimension schedule 314. Secondly, remainder register 320 is filled with a predefined value.

Next, a bit stream on input 301 is received by calculation controller 310, which successively processes each bit as follows. The bit value is sent to remainder register 320 and is shifted into the lowest bit position. The upper bit shifted out of the remainder register 320 is sent back to calculation controller 310, which responds by performing a divide when the value is one.

The divide operation consists of using dimension selector 312 to select an index value from dimension schedule 314. This index then selects a register from polynomial table 316, which is comprised of an array of registers labeled polynomial 1 through polynomial K. Subsequently, the value of the selected polynomial is sent to xor unit 318, and is xored with the value from remainder register 320. The xor result is stored back in remainder register 320.

The final step of processing each input bit is to advance dimension selector 312 so it points to the next index register in dimension schedule 314, which is accomplished by incrementing the value, subject to wrapping to the first register in the array.

After all bits from input 301 are processed, calculation controller 310 performs a padding operation, which is typical for CRC calculations. Namely, a sequence of 0 bit values are processed as if coming from input 301. The preferred sequence length is the number of bits in remainder register 320, but length of zero is also valid, which effectively bypasses the padding operation. After the padding operation, the contents of remainder register 320 are routed to output 322 as the result the MD-CRC calculation. The multi-dimensional CRC is a novel improvement.

A judicious choice of polynomials is needed for good MD-CRC results. Unfortunately, finding a good polynomial for even a standard CRC is somewhat of a black art. The polynomial hunt for a MD-CRC is more complicated as several polynomials are needed and their order. However with MD-CRC, there is the opportunity for smoothing with adjacent polynomials offsetting the aberration introduced by the prior polynomial. Hence, it should be possible to use good polynomials in a MD-CRC configuration to obtain better results that what the individual polynomials provide. Preliminary investigations have bore this out. Also note that software CRC implementations almost always use a lookup table base on 8-bit entries. An 8 dimension MD-CRC can be identically implemented with a lookup table of the same size. Thus, MD-CRC can provide the same performance but with a much richer underlying polynomial space.

The MAE keystream generators of the present invention employ several MD-CRC units whose purpose is similar to that of a hashing function. While a secure hash is not critical, it would be an improvement, particularly for the MD-CRC's used in message key exploder 13. A common way to achieve a more secure computation is through feedback. Readily, MD-CRC calculator 300 lends itself to the feedback of remainder register 320 bits. Namely, a feedback schedule can be defined so that certain remainder register bits are extracted at predefined intervals. These bits are stored and then subsequently xored to the input bits and/or divide signal bits in accordance with the feedback schedule so as to modify when the polynomial registers are applied.

Another enhancement for MD-CRC evaluation is to extend the dimension schedule. Since a fast software implementation is usually required, dimension schedule 314 will typically contain 8 indexes (j=8). This aligns with a table-driven implementation that processes 8 input bits at a time, which is the industry norm because 8 is the most practical value. Increasing the dimension schedule in multiples of 8 entails creating an additional lookup table for each additional 8 indexes, which the above detail description fully covers.

But the dimension schedule enhancement being presented here regards using a multiplicity of dimension schedule/dimension selector pairs wherein each dimension schedule would typically contain 8 indexes. The calculation controller would now need the additional capability to select which schedule is in effect and for how many cycles according to a control list that specifies these parameters, which are used in a circular fashion. This provides for a richer usage of polynomials while retaining the benefits of 8 bit lookup tables.

As an example in accord with the MAE machines previously described, the size of the MD-CRC is 640 bits and it contains two dimension schedules. The control list specifies that the first schedule is used for 64 cycles (processing one byte per cycle) with the second schedule operating for 8 cycles. This is a good way to periodically inject a randomizing effect from another set of polynomials, and it makes the evaluation more secure.

9. Conclusions and Benefits

MAE is a family of encryption systems that can be geared towards hardware or software implementations, or both, with minimal compromise. These provide very high entropy systems with native support for a wide range of keys sizes. Fast, uniform performance is achieved even with very large keys via an immense internal encryption engine. Eschewing compact complexity, MAE relies upon dispersed complexity based on memory and simple operations, which are quite practical on modern CPUs, and with modern chip fabrication in general. Of particular importance is MAE's use of parallelizable partition evaluation to provide low latency. It can be argued that MAE's cryptographic security (of the strongest embodiments) will easily survive decades of advances in cryptography and computer technologies.

Encryption is nearly everywhere. One field of applications particularly well suited for MAE is that of digital communications such as wireless networks and smart phones. The single emit morphing embodiment is a good choice for these applications as it is fast, has a relatively small chip size, and yet is highly secure.

Another potential application for MAE is within computer systems. A canonic mode monobase amorphous encryption system could be build into say the southbridge chipset. This would be an excellent choice for a long term algorithm that could provide even server level performance via MAE's low latency and high generation rate.

Securing computer network traffic is another good application for canonic mode MAE. The low latency made possible via parallelizable partition evaluation and a public base key makes including MAE on a network card a solid choice. In addition, since MAE is a stream cipher, queuing keystreams is possible wherein latency could totally be eliminated.

The embodiments described above are to be understood as illustrative of the principles taught by the present invention. Other embodiments may readily be devised that embody the principles in spirit and scope. It is to be further understood that the embodiments described herein are not limited to the specific forms shown by way of illustration, but may assume other embodiments limited only by the scope of the appended claims.

What is claimed is:

1. A machine for generating a cryptographic keystream based on an expanding amorphous process including:
1) a base key memory storing essentially random bits that form the basis of the keystream generation process;
2) an initial partition index source providing an essentially random number called an amorphous partition index;
3) one or more partition extractors evaluating a partition on the base key by calculating values called elements in accordance with the amorphous partition index, each element being calculated from parameters called specification fields, each specification field extracted from the amorphous partition index;
wherein partition evaluation is parallelizable via specification fields that can be independently evaluated per element;
4) an emission generator forming from the elements values element emissions, where each element emission is a stream of random bits generated in accordance with its element descriptor, with each element emission being generated piecemeal in units called emission fragments;
5) a plurality of multiplexing slots each storing multiplexing parameters that are formed by the one or more partition extractors; and
6) a multiplexer multiplexing bits from the emission fragments in accordance with multiplexing slots to form an amorphous stream;
wherein the amorphous stream is generated by a process that is amorphous, and is thus suitable to serve as a cryptographic keystream.

2. The machine according to claim 1 wherein the 1) base key memory includes at least one set of random bits that is both public and universally known.

3. The machine according to claim 1 wherein the 1) base key memory becomes filled in any one iteration of the process with a portion of the partition index.

4. The machine according to claim 1 further comprising:
morphing means for periodically morphing, meaning transforming, 1) base key memory during generation of the amorphous stream;
wherein periodic morphing includes morphing the base key memory after each carving of a partition index, or alternatively, morphing the base key memory after a multiplexer block holdback.

5. The machine according to claim 4 wherein the morphing means comprises:
1) a source of random bits; and
2) a cycle counter determining a cycle count with the value derived from the random source bits; and
3) a cycle modifier repetitively modifying a portion of the base key memory by successively retrieving random source bits used to specify a starting position, a transform size and datum value;
wherein the datum value of length transform size is xored to the base key memory beginning at address specified by the starting position.

6. The machine according to claim 4 wherein the morphing means comprises:
1) a source of random bits from which datum values are successively derived; and
2) a coverage addresser that defines a sequence of addresses, coverage addressers including:
2.1) an addresser that generates consecutive base key addresses;
2.2) an addresser that stripes the base key addresses by emitting a starting address followed by the sequence of its nth successors, followed by the starting address's immediate successor and its sequence of its nth successors, repeating until all addresses are emitted; and
3) An xor element xoring datum values to the base key memory at the addresses specified by coverage addresser;
wherein successive morphing operations will eventually cover the base key.

7. The machine according to claim 1 wherein the 2) initial partition index source comprises:
a message key exploder transforming a message key and a key delta into an amorphous partition index, the message key exploder including:
2.1) an exploder router for combining the message key and key delta into a work key, for decomposing the work key into one or more substrings;
2.2) one or more multi-dimensional CRC evaluators each for evaluating a hash value of a substring;
wherein alternately each substring is pre-hashed before sent to its multi-dimensional CRC evaluator;
2.3) one or more randomizers each corresponding to a multi-dimensional CRC evaluator and each generating a stream of random bits; and
2.4) a combiner combining the random bits to form an amorphous partition index.

8. The machine according to claim 1
wherein the 3) partition extractor employs two or more source start specification fields, both associated to same element, which are independently evaluated.

9. The machine according to claim 1
wherein the 3) partition extractor employs a source start specification field that defines an initial source location that is essentially a random address within the base key.

10. The machine according to claim 1
wherein the 3) partition extractor includes a dynamic sources means that periodically refills element sources, the dynamic sources means comprising:
3.1) a source specification field value generator for generating source specification field values, generators including:
3.1.1) forming source specification field values from a random source; and
3.1.2) forming source specification field values from a random source and source specifier registers, the source specification field values being the result of xoring the next bits from the random source with certain bits in source specifier registers wherein the source specifier registers are not modified, or alternatively, updating the source specifier registers with values from the source specification field values;
wherein each element has source specifier registers per element source, each set of source specifier registers being initialized from the corresponding source specification fields extracted from the partition index during partition carving;
3.2) a source filling means for filling a source, a source being filled by evaluating source specification field values;
3.3) a controller for filling element sources, the controller operating by passing source specification field values from the source specification field value generator to the source filling means, controllers including:
3.3.1) filling a source on an element after the source is exhausted; and
3.3.2) filling all sources on an element after one of the element's sources is exhausted.

11. The machine according to claim 1
wherein the 3) partition extractor employs an initial fragment size specification field that defines the number of bits to generate when filling the corresponding element's emission fragment register for the first time.

12. The machine according to claim 1
wherein the 3) partition extractor employs two or more source rotation specification fields, both associated to same element, which are independently evaluated.

13. The machine according to claim 1
wherein the 3) partition extractor employs a combinatory specification field that randomly selects an element descriptor for use in initializing a multiplexing slot.

14. The machine according to claim 1
wherein the 3) partition extractor employs an initial holdback evaluation means in which the initial holdback specification field is applied proportionally to the master holdback's value to derive an initial holdback value.

15. The machine according to claim 1 wherein the 3) partition extractor includes:
3.4) an element recarver for recarving an element, the element recarver comprising:
3.4.1) a source of recarving bits; and
3.4.2) a routing mechanism to receive recarving bits, acting to form a partition element specifier and subsequently recarve a specific element, means for forming a partition element specifier including:
3.4.2.1) concatenating the recarving bits; and
3.4.2.2) xoring part or all of the previous partition element specifier bits with recarving bits;
wherein the register(s) representing the element's previous partition element specifier are preserved, or alternatively, the newly formed partition element specifier is stored back in said register(s).

16. The machine according to claim 1 wherein the 3) partition extractor includes:
3.5) a partial element recarver for transforming up to all of the elements but only a portion of each element, the partial element recarver comprising:
3.5.1) a source of recarving bits; and
3.5.2) a routing mechanism to receive recarving bits, acting to form element specification fields and subsequently recarve a portion of one or more specific elements, means for forming element specification fields including:
3.5.2.1) concatenating the recarving bits; and
3.5.2.2) xoring part or all of the previous element specification fields bits with recarving bits;
wherein the register(s) representing the element's previous element specification fields are preserved, or alternatively, the newly formed element specification field vales are stored back in said register(s);
wherein partial recarving is performed after a predefined event, including after a block holdback.

17. The machine according to claim 1 further comprising:
a dispersed seed evaluator deriving one or more dispersed seeds from an amorphous partition index, the dispersed seed(s) being used to seed random number generation process(es);
wherein the dispersed seed evaluator comprises a hash method, including MD-CRC evaluators.

18. The machine according to claim 17
wherein the dispersed seed evaluator successively receives a portion of a partition index, computes a reduced value for each portion using a reducing hasher, acts as a dispersing hasher to successively receive the reduced value for each portion, and calculates a hash value which defines the dispersed seed.

19. The machine according to claim 1 wherein the 4) emission generator comprises:
a rotating and xoring means both rotating and xoring a plurality of source values together to form the emission fragment in a word orientated manner.

20. The machine according to claim 1 wherein the 4) emission generator comprises:
an xoring means for xoring source derived values together, the xoring means comprising:
a detector determining when all sources have the same address whereupon the xored result is further xored with additional xoring bits to form the emission fragment value.

21. The machine according to claim 1 wherein the 4) emission generator comprises:
a plurality of assigned sources comprising:
4.1) a pool of sources, the pool containing a plurality of sources with each element assigned to one or more sources;
4.2) a source index deriver for deriving source indexes, a source index selecting a source from the pool, source index derivers including:
4.2.1) forming the source index from a random source; and
4.2.2) forming the source index from a random source and an assignment register, the source index being the result of xoring the next bits from the random source with the assignment register value
wherein the assignment register is not modified, or alternatively, updating the assignment register with the source index value;
wherein each element has an assignment register per element source, each assignment register value calculated from an assignment specification being derived from the partition extraction means, the assignment registers being initialized during partition carving;
4.3) a reassignment means for changing the source assignment for one or more elements, reassignment means using the source index deriver to select the sources, wherein one or more sources (but not necessarily all) are changed for a particular element, including by checking if the same source is assigned two or more times to a particular element in which case the reassignment means chooses other sources to eliminate any collisions, the choosing of other sources including incrementing one or more of the effective source indexes and including deriving additional source indexes until all collisions are eliminated, reassignment means including:
4.3.1) reassigning all element sources each time a countdown register is decremented to zero;
wherein the countdown register is decremented after each block holdback, with the countdown register initialized after the initial partition carving, initialized when decremented to zero, and including initialization again after each subsequent partition carving, with an initialization value either a fixed value or alternatively a randomly derived value;
4.3.2) reassigning all sources of an element when its emission fragment registered is refilled; and
4.3.3) reassigning a source on an element when its source's datum register is refilled;
4.4) an initialization means for assigning sources to the elements after each partition carve, initialization means including:
4.4.1) initializing the element sources in a fixed manner with sources from the pool, including sequential assignment of pool sources to elements; and
4.4.2) initializing the element sources in a random manner using a source index deriver, or alternatively, using specification fields to define the source indexes, including using source index collision adjustments;
4.5) a source recarving means for recarving sources in the pool, source recarving means including:
4.5.1) no source recarving at all;
4.5.2) recarving the sources that were previously assigned to a recarved element wherein source recarving occurs when the element is recarved; and
4.5.3) recarving the sources that were just assigned to a recarved element wherein source recarving occurs when the element is recarved.

22. The machine according to claim 1 wherein the 6) multiplexer comprises:
6.1) a block holdback trigger for holding the number of countdown events before skipping a block of elements;
wherein the block holdback trigger is decremented for each countdown event, the countdown event including:
6.1.1) an emission to the amorphous stream;
6.1.2) normal emission holdback;
6.2) a block holdback size for holding the number of elements to skip when a block holdback occurs; and
6.3) a multiplexing controller means that includes a means for decrementing the block holdback trigger upon each countdown event, for detecting when the block holdback trigger is zero, for advancing the slot index (that selects the element being multiplexed) by the contents of the block holdback size when the trigger is zero and then subsequently to refill the block holdback trigger and block holdback size from a random stream.

23. The machine according to claim 1 wherein the 6) multiplexer means further comprises:
6.4) mixing means to further shuffle bits as the final stage of amorphous stream generation;
wherein the mixing means is periodically initialized including during each partition carving.

24. The machine according to claim 23 wherein the 6.4) mixing means comprises:
6.4.1) a mixing rotator being a multi-segmented shift register;
6.4.2) a random source used to specify rotation counts; and
6.4.3) a mixing controller means used to generate the amorphous stream by repetitively loading the mixing rotator with emission bits, by applying random source bits to rotate the emission bits in the mixing rotator, and finally to output the mixing rotator's content as the next portion of the amorphous stream.

25. The machine according to claim 1 wherein the 6) multiplexer further comprises:
6.5) a phased multiplexing comprising
6.5.1) a plurality of multiplexing slots for each element, each element having a multiplexing slot for each phase, which provides for independent holdback parameters per phase per element,
6.5.2) a phase selector register used for selecting the multiplexing slot in effect for the selected element, and
6.5.3) a control means that provides for advancing the phase selector after each emission.

26. The machine according to claim 1
wherein the 6) multiplexer employs alternate next element advancement comprising:
6.6) a pool of next pointers per element, each pool containing one or more next pointers, including next pointers of the following types:
6.6.1) fixed increment next pointers, each pointer being a fixed n^{th} successor of the current element;
6.6.2) delta derived next pointers, each pointer being an n h successor of the current element with n (the delta) computed by adding an element specification field value to a base value;
6.6.3) selected next pointers, wherein an element specification field value is used to select a pointer from a set of fixed increment next pointers;
6.7) a selection evaluator evaluating a selection value used as an index to select a next pointer from the pool, selection evaluators including:
6.7.1) forming the selection value from a random source;
6.7.2) deriving the selection value from the current element's state;
6.7.3) forming the selection value from a buffer by successively emitting buffer bits in a sequential and cyclic manner; or alternately xoring the emitted buffer bits with bits derived from the current element's state to form the selection value;
wherein the buffer is initialized from a random source, or alternately initialized via a portion of the partition index; and
6.7.4) outputting a constant as the selection value;
wherein the multiplexer overrides the default element advancement by advancing the element to the element specified by the next pointer selected from the pool via the selection value each element emission; or alternatively after each standard holdback, or alternatively still after each element emission and standard holdback.

27. The machine according to claim 1
wherein the 6) multiplexer employs alternate next element advancement comprising:
6.8) a random source providing a sequence of random values:
6.9) a base register per element holding a base value initialized from an element specification field;
6.10) a next element evaluator evaluating a next element index, next element evaluators including:
6.10.1) forming a next element index by adding a delta value to the current element index, the delta value formed by xoring the next random source value with the base value;
wherein alternatively the delta value is then stored in the base register to provide a new base value;
6.10.2) forming a next element index by xoring the next random source value with the base value;
wherein alternatively the xored result is then stored in the base register to provide a new base value;
wherein the multiplexer overrides the default element advancement by advancing the element to the element specified by the next element evaluator after each element emission; or alternatively after each standard holdback, or alternatively still after each element emission and standard holdback.

28. The machine according to claim 1
wherein the 6) multiplexer employs alternate next element advancement comprising:
6.11) a random source providing a sequence of random values:
6.12) a next element evaluator evaluating a next element index, next element evaluators including:
6.12.1) forming a next element index by adding a delta value to the current element index, the delta value defined as the next random source value;
6.12.2) using the next random source value as the next element index;
wherein the multiplexer overrides the default element advancement by advancing the element to the element specified by the next element evaluator after each element emission; or alternatively after each standard holdback, or alternatively still after each element emission and standard holdback.

29. The machine according to claim 1 further comprising:
one or more internal emissions generator(s) each generating an internal emissions used to provide a random source for path bits, substitution bits, recarving bits and the like;
and wherein an internal emissions generator comprises:
1) an internal random source;
2) a plurality of internal emission registers each for holding a random value;
3) a filling means to initialize the internal emission registers with values from the internal random source; or alternatively, using partition index data for the initialization data;
4) an emission means to generate an internal emission value, the emission means comprises:
4.1) a selection value evaluator for forming a selection value, selection value evaluators including:
4.1.1) forming the selection value from a random source;
4.1.2) deriving the selection value from the current element's state;
4.1.3) using a specification field value to define the selection value; and
4.1.4) outputting a constant as the selection value;
4.2) an index evaluator for forming an index that selects an internal emission register, index evaluators including:
4.2.1) deriving the index from the effective element index;
4.2.2) using the selection value to select a specification field value that is used as the index;
4.2.3) using a specification field value as the index; and
4.2.4) forming the index from a random source;
4.3) a selection process for selecting an internal emission register to provide the next internal emission value with the selected internal emission register subsequently refilled using the next value from the internal random source, or alternately using the next internal random source value directly as the internal emission;
wherein the selection is based on the selection value and the index if multiple internal emission register exists within the scope of the selection;
wherein the emission means is evoked after a predefined event occurs, predefined events including:
4.4) an emission fragment being refilled;
4.5) an element emission.

30. The machine according to claim 1 further comprising:
7) an incremental partition carving means for carving subsequent partitions piecemeal,
wherein a portion of the amorphous stream is routed after a predefined event as the next partition index component, predefined events including:
7.1) a block holdback;
7.2) after a fixed number of bits are outputted; and
7.3) after a random number of bits are outputted;
wherein a random source provides the random output count;
wherein one or more partition index components are cached and then used to carve one or more elements, with the elements carved in a predefined order, including a sequential order.

31. A method for generating a cryptographic keystream, comprising:
1) storing random bits in a base key memory, including storing bits that are publicly and universally known and alternatively storing bits from a portion of the partition index;
2) providing an essentially random number called an amorphous partition index, including:
2.1) transforming a message key and a key delta into substring(s), evaluating a MD-CRC value from a substring which may include pre-hashing the substring, generating a random stream from each MD-CRC value and combining stream(s) to form an initial partition index;
3) evaluating a partition on the base key by calculating elements, calculating elements from specification fields, extracting specification fields from the amorphous partition index, wherein evaluating a partition may include:
3.1) extracting two or more source start specification fields, associating to same element, evaluating independently;
3.2) extracting a source start specification field for deriving an essentially random base key address;
3.3) refilling element sources dynamically, generating source specification field values, evaluating said field values into a source, including refilling an element's source after it is exhausted or alternatively refilling all sources on an element after one is exhausted;
3.4) extracting an initial fragment size specification field for defining size for initial filling of corresponding emission fragment register;
3.5) extracting two or more source rotation specification fields, associating to same element, evaluating independently;
3.6) extracting a combinatory specification field for selecting an element for a multiplexing slot;
3.7) evaluating an initial holdback specification field in proportion to its master holdback's value;
3.8) recarving an element by forming a partition element specifier from a source of recarving bits, evaluating said specifier into an element;
3.9) partially recarving an element by forming element specification field value(s) from a source of recarving bits, evaluating the specification field value(s) into portions of an element; and
3.10) forming dispersed seed(s) by hashing portions of amorphous partition index, including forming reduced values by hashing portions and then hashing reduced values;
4) forming random streams called element emissions from elements, generating emission fragments in accordance with corresponding element, concatenating emission fragments into an element emission, wherein forming element emissions may include:
4.1) rotating and xoring a plurality of source values, accumulating and rotating to form an emission fragment;
4.2) forming emission fragment by xoring source derived values, detecting if all sources have same address whereupon xoring prior result with additional xoring bits;
4.3) forming emission fragments using assigned sources, creating a pool of sources, selecting sources from the pool, establishing an initial assignment of sources to elements including sequential and random assignment of pool sources to elements, reassigning sources to elements including reassigning all element sources periodically and reassigning an element's sources when refilling its emission fragment, wherein forming fragments may include recarving sources in the pool;
5) storing multiplexing parameters in multiplexing slots, evaluating multiplexing parameters from specification fields extracted the amorphous partition index; and
6) multiplexing emission fragments bits in accordance with multiplexing slots, forming amorphous stream for use as cryptographic keystream, wherein multiplexing may include:
6.1) decrementing a block holdback trigger including after each normal emission holdback, advancing the element selected by a block holdback size, refilling trigger and holdback size after advancing;
6.2) mixing multiplexed bits as final stage of amorphous stream formation including rotating bits in a multi-segmented rotator using random rotation values;
6.3) accessing holdback parameters per phase for an element, advancing phase after element emission;
6.4) forming pool of next pointers for an element including using fixed increment and/or randomly derived next pointers, selecting a next pointer from pool, advancing to element specified by selected next pointer;
6.5) evaluating a next element index by combining a base value derived from a specification field corresponding to element with another value from a random source, advancing to the element specified by said index; and
6.6) evaluating a next element index, forming a random value from a random source, including adding random value to current element index to form index and using random value as index, advancing to the element specified by said index.

32. The method according to claim 31 wherein the 1) storing random bits in a base key memory may include:
1.1) transforming base key bits by periodically morphing bits while generating amorphous stream, including:
1.1.1) selecting randomly consecutive base key bits, modifying selected bits with random bits; and
1.1.2) defining a sequence of base key addresses including using consecutive addresses, modifying value at address with a random datum value;
wherein random sources used for forming cryptographic keystream may include one or more internal emissions generator(s) comprising:
filling internal emission registers including via a random source and alternatively via the partition index, forming selection value including from a random source, forming an index selecting an internal emission register including using the selection value for selecting a specification field value as the index, generating internal emission value by selecting internal emission register value via index, refilling internal emission register;
wherein a subsequent partition carving may include incrementally carving the partition by extracting a portion of the amorphous stream at intervals, carving partition element(s) from portion.

33. A machine for evaluating multi-dimensional cyclic redundancy codes, MD-CRC, the machine comprising:
1) a polynomial table element, being a plurality of polynomial registers, each polynomial register used to store a bit array that represents a polynomial;
2) a dimension schedule element, being a plurality of index registers, each index register used to select a polynomial register within the polynomial table element;
3) a dimension selector, being a register for selecting an index register within the dimension schedule element to thus selects a polynomial register, which is initially set to select first index in the dimension schedule;
4) a remainder register, being a shift register of the same size as a polynomial register, used for calculating the MD-CRC value;
5) an xor unit for performing bitwise exclusive-or operations; and
6) a calculation controller means for managing the MD-CRC evaluation process, the calculation controller means comprising:
6.1) an initialization means to fill the remainder register with a predefined value;
6.2) a cycling means to successively receive an input bit, to send the input bit to the remainder register which shifts it into the lowest bit position, to receive a trigger bit being the upper bit shifted out of the remainder register, to conditionally xor the remainder register with the selected polynomial when the trigger bit has a value of 1, and to advance the dimension selector; and
6.3) a padding means to repetitively evoke the cycling means after all input bits are processed,
wherein a value of 0 is used as the input bit value with valid repetition count values including the number of bits in the remainder register and zero.

34. The machine according to claim 33 wherein the MD-CRC evaluation machine further comprises:
7) a multiplicity of dimension schedule and dimension selector pairs;
8) a control list, being an array of register pairs, each pair comprising an index that selects a dimension schedule and a cycle count corresponding to that schedule;
9) a control index, being a register that selects the active pair within the control list, which is initially set to select the first pair; and
10) a cycle counter, being a counter used to represent the number of remaining cycles for the active dimension schedule;
wherein the 6) calculation controller means further comprises:
6.4) a schedule cycling means to read the selected cycle count from the control list, to store this value in the cycle counter, and to repetitively apply the 6.2) cycling means using the selected dimension schedule, decrementing the cycle counter after each cycle, until the cycle counter reaches zero, whereupon the control index is advanced with evaluation continuing with the next dimension schedule.
